(19) United States
(12) Patent Application Publication
(10) Pub. No.: US 2008/0278027 A1
(43) Pub. Date: Nov. 13, 2008

(54) MOTOR AND METHOD FOR MANUFACTURING THE MOTOR

(75) Inventors: Hideya IKEMOTO, Kyoto (JP); Hidehiko HIDAKA, Kyoto (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NIDEC CORPORATION, Kyoto (JP)

(21) Appl. No.: 12/117,345

(22) Filed: May 8, 2008

(30) Foreign Application Priority Data
May 9, 2007 (JP) 2007-124585

(51) Int. Cl. H02K 1/12; H02K 15/02

(52) U.S. Cl. 310/254; 29/596; 310/42

(57) ABSTRACT

A motor includes a shaft; a sleeve that supports the shaft rotatably; a housing including a cylindrical holding portion for holding an outer circumferential surface of the sleeve; a stator held against the cylindrical holding portion; and an attachment plate including an attachment portion held against the outer circumferential surface of the cylindrical holding portion. Herein, the cylindrical holding portion has a stator holding surface section facing the stator in a radial direction and an attachment plate holding surface section facing the attachment portion of the attachment plate in a radial direction. Further, the stator holding surface section has an outer diameter greater than that of the attachment plate holding surface section, and the inner circumferential surface of the cylindrical holding portion includes a surface region opposite to the stator holding surface section and another surface region opposite to the attachment plate holding surface section.

### FIELD OF THE INVENTION

The present invention relates to a motor having a housing formed by press working and a method for manufacturing the motor.

### BACKGROUND OF THE INVENTION

Along with price reduction of a disk drive apparatus for recording and reproducing an optical disk, there is an increasing demand for cost reduction of a motor with which the disk drive apparatus is equipped. For this reason, constituent parts of a motor are being changed from cut products or molded products to cost-effectively producible press-formed products.

A conventional motor that employs press-formed products will now be described with reference to FIG. 24, which is an axially-cut schematic section view illustrating a conventional motor.

Referring to FIG. 24, the motor 1 includes a shaft 2 rotatably arranged in a coaxial relationship with a center axis J1; a cylindrical sleeve 3 for rotatably supporting the shaft 2 in a radial direction; a cylindrical housing 4 for holding an outer circumferential surface of the sleeve 3; a stator 5 fixed to an outer circumferential surface of the housing 4; a rotor magnet 6 arranged to face the stator 5 in a radial direction, which is rotated together with the shaft 2 as a united body; a rotor holder 7 fixed to an upper portion of the shaft 2 for holding the rotor magnet 6; a chucking device 8 arranged on an upper surface of the rotor holder 7 for holding a disk in a removable manner; and an attachment plate 9 for covering a lower side of the stator 5, the attachment plate 9 having a recess portion 9a for closing off lower openings of the sleeve 3 and the housing 4.

A thrust plate 9b for rotatably supporting the shaft 2 in an axial direction is arranged on an upper surface of the recess portion 9a (see, e.g., Patent Document 1 for an example of prior art documents disclosing the structure of such a conventional motor). (Patent Document 1) Japanese Patent Application Publication No. 2005-323420A

In the motor 1, the housing 4 and the attachment plate 9 are fixed to each other by bringing an inner circumferential surface of the recess portion 9a formed in the attachment plate 9 into contact with the outer circumferential surface of the housing 4. Furthermore, the stator 5 is brought into contact with and fixed to the outer circumferential surface of the housing 4 that has a coaxial relationship with the stator 5. Due to this structure, a portion of the outer circumferential surface of the housing 4 that is in contact with the recess portion 9a is temporarily brought into contact with the stator 5 before it comes into contact with the recess portion 9a. This means that the portion of the outer circumferential surface of the housing 4 that is in contact with the recess portion 9a may possibly deformed by the contact with the stator 5.

In particular, if the housing 4 and the attachment plate 9 are fixed to each other by bringing the outer circumferential surface of the housing 4 into contact with the inner circumferential surface of the recess portion 9a, the perpendicularity of the housing 4 relative to the attachment plate 9 is heavily affected by the precision of the outer circumferential surface of the housing 4. Seeing that the portion of the outer circumferential surface of the housing 4 that is in contact with the recess portion 9a is the lower end portion of the housing 4, the precision of that region has a particularly heavy influence on the perpendicularity of the housing 4 relative to the attachment plate 9. If the perpendicularity of the housing 4 relative to the attachment plate 9 is impaired, the shaft 2 is inclined relative to the attachment plate 9 via the sleeve 3.

The attachment plate 9 is attached to a chassis (not shown) of a disk drive apparatus. An optical pickup mechanism (not shown) is attached to the chassis substantially in parallel to the attachment plate 9. The optical pickup mechanism emits light upwardly in an axial direction to record or reproduce information on or from the rear surface of a disk. That is to say, the light of the optical pickup mechanism is irradiated perpendicularly to the attachment plate 9.

If, however, the shaft 2 is inclined relative to the attachment plate 9 (namely, if the shaft 2 fails to make a right angle relative to the attachment plate 9), the chucking device 8 indirectly attached to the shaft 2 is also inclined. In other words, the disk is not held in parallel to the attachment plate 9 but mounted in a tilted state. As a result, the light of the optical pickup mechanism is not irradiated perpendicularly to the disk, which leaves a possibility that errors occur in a recording or reproducing process.

### SUMMARY OF THE INVENTION

In view of the above, the present invention provides a motor in which an attachment plate is attached to a housing with increased precision; a disk drive apparatus equipped with the motor; and a method for manufacturing the motor.

In accordance with a first aspect of the present invention, there is provided a motor including a shaft capable of being rotated about a center axis; a sleeve of a substantially cylindrical shape having an inner circumferential surface that supports the shaft rotatably; a housing of a substantially cylindrical shape including a cylindrical holding portion having an inner circumferential surface for holding an outer circumferential surface of the sleeve; a stator, held against an outer circumferential surface of the cylindrical holding portion, for generating a rotating magnetic field; and an attachment plate, arranged axially below the stator, including an attachment portion held against the outer circumferential surface of the cylindrical holding portion.

Herein, the housing is made of a press-formed metal plate. Further, the outer circumferential surface of the cylindrical holding portion has a stator holding surface section facing the stator in a radial direction and an attachment plate holding surface section facing the attachment portion of the attachment plate in a radial direction, wherein the stator holding surface section has an outer diameter greater than that of the attachment plate holding surface section. Further, the inner circumferential surface of the cylindrical holding portion includes a surface region opposite to the stator holding surface section and another surface region opposite to the attachment plate holding surface section, the surface regions being in contact with the outer circumferential surface of the sleeve.

In this configuration, the housing is formed by pressing a metal plate. Therefore, it is possible to greatly reduce the manufacturing cost of the housing as compared to a conventional housing produced by cutting a brass material.

Furthermore, since the stator holding surface section and the attachment plate holding surface section of the outer circumferential surface of the cylindrical holding portion make contact with the outer circumferential surface of the sleeve, it is possible to increase the strength with which the sleeve is held in place by means of the housing.

In addition, inasmuch as the stator holding surface section has an outer diameter greater than that of the attachment plate holding surface section, it is possible to prevent the stator from making contact with the attachment plate holding surface section while fixing the stator to the stator holding surface section. Therefore, it is possible to prevent deformation of the attachment plate holding surface section which might otherwise occur due to a temporary contact between the attachment plate holding surface section and the stator. This makes it possible to attach the attachment plate to the housing with increased precision.

It is preferable that the stator is fixed to the stator holding surface section at least by press-fitting.

Thus, since the stator is fixed to the stator holding surface section by press-fitting, it is possible to bring the center of the cylindrical holding portion into alignment with the center of the stator with increased precision. Further, the outer diameter of the stator holding surface section is greater than that of the attachment plate holding surface section. Therefore, it is possible to prevent the stator from making contact with the attachment plate holding surface section, thereby preventing deformation thereof due to a temporary contact between the stator and the attachment plate holding surface section in the process of press-fitting the stator to the cylindrical holding portion. This makes it possible to attach the attachment plate to the housing with increased precision.

Further, it is preferable that the stator includes a stator core having a plurality of stator laminations made of punch-formed thin magnetic plate, the stator laminations being laminated one above another in an axial direction. Herein, the stator laminations are punched in a same punching direction, and the stator core has an inner circumferential surface in contact with the stator holding surface section. Further, the attachment plate holding surface section may be inserted in the stator core in the punching direction, and the stator core may be fitted to and held against the stator holding surface section.

In this structure, the stator laminations are formed by punching. Thus, a sagging surface is formed at a circumferential edge on a punching side of each stator lamination. Furthermore, a burr may be formed in a circumferential edge on an opposite side of each stator lamination, wherein the opposite side refers to a side opposite to the punching side. If the cylindrical holding portion is press-fitted to the stator core in a direction opposite to the punching direction of the stator lamination, the burr formed at the circumferential edge of the stator lamination may interfere with the stator holding surface section to thereby complicate the task of fixing the stator core to the stator holding surface section. Further, since the circumferential edge on the opposite side of each stator lamination is formed in an angled shape, it is difficult to fix the stator core to the stator holding surface section.

In the present invention, the stator laminations are fitted to and held against the stator holding surface section in the same direction as the punching direction. In this case, since the punching side of each stator lamination has the sagging surface as described above, it becomes easier to fix the stator laminations. This facilitates the task of fixing the stator core to the stator holding surface section. In addition, it is possible to prevent an excessive force from being applied to the stator holding surface section in a radial direction. Therefore, the precision of the inner diameter of the cylindrical holding portion can be kept from being deteriorated.

Further, it is preferable that a slanting surface whose diameter increases along an axially upward direction is formed between the stator holding surface section and the attachment plate holding surface section.

In this structure, by forming a slanting surface whose diameter increases along an axially upward direction is between the stator holding surface section and the attachment plate holding surface section, the stator can be smoothly fitted to the stator holding surface section in the process of fixing the stator to the stator holding surface section. This makes it possible to further facilitate the task of fixing the stator to the cylindrical holding portion.

Further, it is preferable that the sleeve is a slide bearing impregnated with oil, and the housing includes a bottom portion that closes off a lower end opening of the cylindrical holding portion. Herein, a thrust plate that rotatably supports a lower end portion of the shaft may be disposed on an upper surface of the bottom portion, and the cylindrical holding portion and the bottom portion may be formed as a single body.

If the cylindrical holding portion and the bottom portion are formed of separate members as in the conventional housing, oil of the sleeve serving as an oil-impregnated slide bearing may be leaked through the joint of the cylindrical holding portion and the bottom portion. However, in the above-described structure, the cylindrical holding portion and the bottom portion that closes off the lower end opening thereof are formed as a single body. Thus, it is possible to prevent oil from being leaked from the sleeve, thereby prolonging the lifespan of the sleeve serving as a bearing.

Further, if the cylindrical holding portion and the bottom portion are formed of separate members as in the conventional housing, the cost involved in manufacturing the motor is increased due to the increase in the number of components and the number of fabricating steps. However, in the above-mentioned structure, it is possible to reduce the number of components and the number of fabricating steps by forming the cylindrical holding portion and the bottom portion as a single member. This makes it possible to reduce the cost involved in manufacturing the motor.

Further, it is preferable that the inner circumferential surface of the cylindrical holding portion has a curved surface whose diameter increases along an axially upward direction, the curved surface being formed axially above a surface region in the inner circumferential surface of the cylindrical holding portion opposite to the stator holding surface section.

In this structure, a part of the inner circumferential surface axially lying above the surface region of the stator holding surface section is of a structure having a diameter that increases axially upward. Thus, it is possible to smoothly fit the outer circumferential surface of the sleeve to the inner circumferential surface of the cylindrical holding portion. This helps to facilitate the task of fixing the sleeve to the cylindrical holding portion.

Further, since the part of the inner circumferential surface lying axially above the surface region opposite to the stator holding surface section is formed as a curved surface having an increasing diameter, it is possible to easily form that part by bending the cylindrical holding portion in an outwardly radial direction in the press-forming process. This makes it possible to reduce the cost involved in producing the housing.

Particularly in case of the housing in which the cylindrical holding portion and the bottom portion are formed as a single body, the cylindrical holding portion and the bottom portion are formed by drawing a metal plate. Therefore, it is possible to form the curved surface simultaneously with a drawing work, which is one kind of press working. This makes it possible to reduce the number of steps for producing the housing. As a consequence, it becomes possible to further reduce the cost involved in producing the housing.

Further, it is preferable that the outer circumferential surface of the sleeve is press-fitted to the inner circumferential surface of the cylindrical holding portion, wherein the outer circumferential surface of the sleeve and the inner circumferential surface of the cylindrical holding portion make contact with each other over an axial length of about 4 mm or less. Herein, the axial length may be substantially the same as an axial length over which the outer circumferential surface of the shaft makes contact with the inner circumferential surface of the sleeve

In this structure, since the sleeve and the cylindrical holding portion make contact with each other over an axial length of about 4 mm or less and further that the axial length is substantially the same as an axial length over which the outer circumferential surface of the shaft makes contact with the inner circumferential surface of the sleeve, the cylindrical holding portion is able to reliably hold the sleeve even if the sleeve has a short axial length.

Further, it is preferable that the attachment portion of the attachment plate is formed by burring, wherein the attachment portion of the attachment plate includes an increased diameter portion in which an inner diameter of the attachment portion is larger than in the other part of the attachment portion. Herein, the inner diameter of the increased diameter portion may be greater than an outer diameter of the attachment plate holding surface section, and a portion of the inner circumferential surface of the attachment portion lying axially below the increased diameter portion may be fitted to and held against the attachment plate holding surface section.

In this structure, the attachment portion of the attachment plate formed by burring is fitted to and held against the attachment plate holding surface section at a portion of its inner circumferential surface near the curved portion, it is possible to suppress deformation of the attachment portion which might otherwise occur in the fitting process. This makes it possible to increase the precision with which the attachment plate is attached to the housing.

Further, it is preferable that the attachment portion has a radial thickness of about 0.6 mm or less.

In this structure, the attachment portion has a radial thickness of about 0.6 mm or less. Thus, it is possible to press-form the attachment plate with a reduced thickness. This assists in providing a low-profile motor. Further, even when the attachment plate is made thin, it is possible to restrain deformation of the attachment portion in the fitting process by fixing the attachment plate to the attachment portion at its region near the curved portion.

Further, it is preferable that an adhesive agent is filled between an inner circumferential surface of the increased diameter portion of the attachment portion and the attachment plate holding surface section.

In this structure, an adhesive agent is filled between the inner circumferential surface of the increased diameter portion and the attachment plate holding surface section. Thus, it is possible to increase the holding strength between the housing and the attachment plate. Therefore, even if the contact area between the inner circumferential surface of the attachment portion and the attachment plate holding surface section is reduced, it is still possible to maintain the holding strength between the housing and the attachment plate. This helps to further suppress deformation of the attachment portion in the fitting process.

Further, it is preferable that a slanting surface whose diameter increases along an axially upward direction is formed at an upper edge of the inner circumferential surface of the increased diameter portion.

By forming the slanting surface, it is possible to smoothly guide the attachment portion toward the attachment plate holding surface. This makes it possible to prevent an unbalanced load from being imposed in a radial direction between the attachment portion and the attachment plate holding surface section. As a result, it is possible to attach the attachment plate to the housing with increased precision.

Further, it is preferable that a slanting surface whose diameter increases along an axially upward direction is formed between the inner circumferential surface of the increased diameter portion and a part of the inner circumferential surface of the attachment portion that is in contact with the attachment plate holding surface section.

In this structure, a slanting surface whose diameter increases along an axially upward direction is formed between the inner circumferential surface of the increased diameter portion and a part of the inner circumferential surface of the attachment portion that is in contact with the attachment plate holding surface section. Thus, it is possible to easily fit the attachment portion to the attachment plate holding surface section. Further, owing to the presence of this slanting surface, it becomes possible to attach the inner circumferential surface of the attachment portion to the attachment plate holding surface section with increased precision.

Further, it is preferable that a radially inwardly curved portion is extended from a lower end of the attachment plate holding surface section.

In this structure, a curved portion is extended from a lower end portion of the attachment plate holding surface section. Thus, it is possible to increase the resistance against the force that compresses the attachment plate holding surface section. This makes it possible to restrain deformation of the attachment plate holding surface section caused by the force applied to the attachment plate holding surface section while the attachment portion is being attached to the attachment plate holding surface section.

Further, it is preferable that a step portion, at which the outer diameter and the inner diameter of the housing are reduced, is formed at an axial lower end of the cylindrical holding portion, and a bottom portion for closing off a lower opening of the housing is extended from the step portion. Herein, a washer whose inner diameter is smaller than that of the sleeve may be arranged between a bottom surface of the sleeve and an upper surface of the step portion. Further, a reduced diameter portion may be formed at a part of the outer circumferential surface of the shaft that faces the washer in a radial direction, and the reduced diameter portion may have an axial length greater than that of an inner circumferential surface of the washer.

This structure makes it possible to prevent the washer and the shaft from making contact with each other during rotation of the motor, except the case that the shaft is moved in an axial direction. Thus, it is possible to avoid getting the washer cut, which might otherwise occur when the shaft makes contact with the washer. As a result, it becomes possible to prevent powdery cutting chips of the washer from entering between the shaft and the sleeve. This, in turn, makes it possible to keep the shaft and the sleeve from being stuck together in a heated state.

Further, in the above structure, it is preferable that the step portion is connected to the cylindrical holding portion via a curved portion. Herein, a downwardly recessed annular groove portion may be formed at an outer circumferential edge of the upper surface of the step portion, and an outer circumferential edge of the washer may be located radially outwardly of an inner circumferential edge of the annular groove portion.

In this manner, it is possible to increase the outer diameter of the washer, which enables the inner circumferential surface of the cylindrical holding portion and the outer circumferential surface of the washer to come closer to each other. Therefore, it is possible to restrain a radial displacement of the washer, thereby preventing the washer from making contact with the reduced diameter portion of the shaft even when the washer is moved in a radial direction.

Further, it is preferable that the motor further includes a rotor holder attached to an upper portion of the shaft, the rotor holder including a cylinder portion for holding a rotor magnet radially facing the stator and a cover portion for covering the stator and the sleeve; and a chucking device arranged on an upper surface of the cover portion of the rotor holder for holding an optical disk having a central opening portion in a removable manner. Herein, a disk support portion for making contact with a lower surface of the optical disk may be provided on an upper surface of the cover portion of the rotor holder radially outwardly of the chucking device.

In general, the motor for rotating an optical disk is attached to a chassis via the attachment plate, and an optical pickup mechanism is attached to the chassis.

Therefore, the inclination of a rotational axis relative to the attachment plate heavily affects the optical axis of the optical pickup mechanism and the disk. In other words, the inclination of a rotational axis relative to the attachment plate affects the recording and reproducing precision of the optical pickup mechanism. For this reason, it is preferred that the attachment plate be attached with no inclination relative to the center axis. Therefore, it is desirable that the structure of the above be applied to the motor for rotating an optical disk to thereby attach the attachment plate to the cylindrical holding portion of the housing with increased precision.

Further, in the above structure, it is preferable that a printed circuit board having an aperture that is substantially coaxial with the center axis is arranged on the upper surface of the attachment plate, an inner diameter of the aperture being greater than an outer diameter of the attachment portion. Herein, an adjustment portion having an axially stepped shape for adjusting an axial distance between a lower surface of the attachment plate and an upper surface of the disk support portion may be formed radially between the attachment portion and the aperture.

The distance between the lower surface of the optical disk and the optical pickup mechanism varies with the kind of the optical pickup mechanism and the shape of a chassis of a traverse unit. Therefore, to produce the housing in different shapes depending on the distance between the lower surface of the optical disk and the optical pickup mechanism, plural kinds of press molds are required accordingly. However, by providing the adjustment portion in the attachment plate, it becomes possible to use only one kind of a housing, whereby a single press mold can be commonly used for producing the housing. Therefore, it is possible to sharply reduce the mold cost for the housing.

Actually, the presence of the adjustment portion in the attachment plate makes it necessary to use plural kinds of molds for producing the attachment plate. However, it is usually the case that the attachment plate is formed by forming a new mold depending on the kind of the disk drive apparatus, because, in most cases, the chassis of the disk drive apparatus to which the attachment plate is attached differs depending on the kind of the disk drive apparatus. That is, it is a usual practice to produce the attachment plate by a new mold where different motors are needed to fabricate different kinds of disk drive apparatuses. Therefore, use of a new mold for production of the attachment plate does not greatly affect the motor manufacturing cost.

Besides, the press mold for production of the housing is more complex and expensive than the mold for production of the attachment plate. This means that preparation of plural kinds of molds for the attachment plate helps to save the overall mold cost compared to the case of preparing plural kinds of molds for the housing.

In addition, by providing the adjustment portion, the cylindrical holding portion and the attachment portion are fixed to each other in the vicinity of the curved portions. This makes it possible to prevent the cylindrical holding portion and the attachment portion from being severely deformed during the fixing process. Therefore, it is possible to attach the attachment plate to the cylindrical holding portion with increased precision.

In accordance with a second aspect of the present invention, there is provided a disk drive apparatus for recording and reproducing data in a disk, including the motor of the above; an optical pickup mechanism for optically recording and reproducing data in the disk; a moving mechanism for moving the optical pickup mechanism in a radial direction of the disk; and a chassis to which the motor is attached. Herein, the chassis has an opening, and the optical pickup mechanism is arranged inside the opening.

In this manner, it is possible to provide a disk drive apparatus that allows the optical pickup mechanism to accurately irradiate light on the lower surface of the disk and also performs the recording and reproducing tasks in a reliable manner. Furthermore, it is possible to provide a highly reliable motor free from locking during its rotation.

In accordance with a third aspect of the present invention, there is provided a method for manufacturing a motor, including providing a shaft capable of being rotated about a center axis; providing a sleeve of a substantially cylindrical shape having an inner circumferential surface that supports the shaft rotatably; press-forming a metal plate into a housing of a substantially cylindrical shape including a cylindrical holding portion having an inner circumferential surface for holding an outer circumferential surface of the sleeve; providing a stator, held against an outer circumferential surface of the cylindrical holding portion, for generating a rotating magnetic field; and providing an attachment plate, arranged axially below the stator, including an attachment portion held against the outer circumferential surface of the cylindrical holding portion.

Herein, the outer circumferential surface of the cylindrical holding portion has a stator holding surface section facing the stator in a radial direction and an attachment plate holding surface section facing the attachment portion of the attachment plate in a radial direction. Further, the stator holding surface section has an outer diameter greater than that of the attachment plate holding surface section. Further, the inner circumferential surface of the cylindrical holding portion includes a surface region opposite to the stator holding surface section and another surface region opposite to the attachment plate holding surface section, the surface regions being in contact with the outer circumferential surface of the sleeve. In addition, the stator is attached to the stator holding surface section by fitting the stator therethroug, and the attachment portion of the attachment plate is attached to the attachment plate holding surface section after the stator has been attached to the stator holding surface section.

If the cylindrical holding portion is press-formed, a cutting trace may be left in the open end of the cylindrical holding portion when cutting a metal plate. This leaves a possibility that a burr is formed in the cutting trace. If the stator is fitted to the burr-formed portion, it is sometimes the case that the stator is damaged and is not accurately attached to the stator holding surface section.

However, in accordance with the third aspect of the present invention, the attachment plate holding surface section has an outer diameter smaller than that of the stator holding surface section. Therefore, it is possible to keep the stator from making contact with the attachment plate holding surface section when the stator is fitted from the side of the attachment plate holding surface section. This makes it possible to attach the stator to the stator holding surface section with increased precision.

It is preferable that the stator and the attachment plate are respectively press-fitted to the stator holding surface section and the attachment plate holding surface section.

In this manner, it is possible to bring the center of the stator into alignment with the center of the housing with increased precision by press-fitting the stator to the housing. When the stator is press-fitted to the stator holding surface section, the attachment plate holding surface section is not affected by the stator passing therethrough. Therefore, it is possible to press-fit the attachment plate to the attachment plate holding surface section with increased precision.

Further, it is preferable that the sleeve is press-fitted to the inner circumferential surface of the cylindrical holding portion of the housing, and a sizing bar for cutting the inner circumferential surface of the sleeve is inserted through the inner circumferential surface of the sleeve when the sleeve is press-fitted to the inner circumferential surface of the cylindrical holding portion.

In this manner, the sleeve is press-fitted to the inner circumferential surface of the cylindrical holding portion in a state that the sizing bar is inserted into the inner circumferential surface of the sleeve. Thus, the sizing bar can restrain deformation of the inner circumferential surface of the sleeve which might be caused when the sleeve is press-fitted to the cylindrical holding portion. Furthermore, since the inner circumferential surface of the sleeve is cut when drawing the sizing bar from the sleeve, it is possible to accurately finish the inner circumferential surface of the sleeve. This makes it possible to form the inner circumferential surface of the sleeve such that it extends accurately in an axial direction, thereby restraining vibratory rotation of the shaft.

Further, it is preferable that an annular flange portion that widens in an outwardly radial direction is formed at an upper end portion of the cylindrical holding portion, and the sleeve is press-fitted to a position where a top surface of the sleeve is flush with an upper surface of the flange portion.

In this manner, it is possible to easily determine the axial position of the sleeve by making the top surface of the sleeve flush with the upper surface of the flange portion. This makes it possible to manufacturing the motor with ease.

Further, it is preferable that a step portion having a reduced outer diameter and a reduced inner diameter is formed at an axial lower end of the cylindrical holding portion, wherein a bottom portion that closes off a lower opening of the cylindrical holding portion is formed in the step portion. Herein, a washer having an inner diameter smaller than that of the sleeve may be arranged axially between a bottom surface of the sleeve and an upper surface of the step portion, and a reduced diameter portion may be formed on the outer circumferential surface of the shaft to face the washer in a radial direction. Further, a tip end portion of the sizing bar may lie substantially in the same axial position as the bottom surface of the sleeve that faces the washer or lies axially above the bottom surface of the sleeve

In this manner, the sizing bar lies substantially in the same axial position as the bottom surface of the sleeve or lies axially above the bottom surface of the sleeve. Thus, it is possible to prevent the sizing bar from making contact with the washer. This makes it possible to prevent the washer from being cut by the sizing bar. As a result, it is possible to avoid generation of sludge including powdery cutting chips of the washer. This helps prevent the motor from being locked by the shaft and the sleeve being stuck together in a heated state.

Further, it is preferable that an annular upper slanting surface and an annular lower slanting surface are respectively formed at an upper and a lower edge of the inner circumferential surface of the sleeve, wherein the lower slanting surface is greater in size than the upper slanting surface.

In this manner, the sizing bar can be easily inserted into the sleeve from the top surface of the sleeve by forming the upper slanting surface. It is also possible to keep the sizing bar from making contact with the upper edge of the inner circumferential surface of the sleeve, which in turn makes it possible to prevent the sizing bar from damaging the upper edge of the inner circumferential surface of the sleeve. By providing the lower slanting surface greater in size than the upper slanting surface, it becomes possible to cut the entire inner circumferential surface of the sleeve that supports the shaft. This makes it possible to increase the precision of the inner diameter of the inner circumferential surface of the sleeve that supports the shaft.

Further, it is preferable that the lower slanting surface and the center axis make an acute angle greater than 0° but smaller than 45°.

In this manner, the lower slanting surface and the center axis make an acute angle greater than 0° but smaller than 45°. Thus, it is possible to restrain volume reduction of the sleeve despite formation of the lower slanting surface. This makes it possible for the sleeve to contain a sufficient quantity of oil, which prevents the motor from suffering from a shortened lifespan. It is also possible to radially inwardly move the radial position in which the upper surface of the washer makes contact with the bottom surface of the sleeve when the inner circumferential surface of the washer is displaced radially upwardly. Therefore, even when the shaft is moved in a removal direction (upwardly in an axial direction), the washer is able to perform the function of preventing removal of the shaft.

Further, it is preferable that the sizing bar has a spiral groove formed on an outer circumferential surface of the sizing bar.

In this manner, a spiral groove is formed in the sizing bar. Thus, it is possible to smoothly cut the inner circumferential surface of the sleeve merely by rotating and drawing the sizing bar from the inner circumferential surface of the sleeve. The powdery cutting chips generated by cutting the inner circumferential surface of the sleeve are moved toward the upper end of the sleeve through the spiral groove, which prevents the powdery cutting chips from staying on the inner circumferential surface of the sleeve. It is also possible to prevent the powdery cutting chips from splashing toward the bottom surface of the sleeve.

Further, it is preferable that an annular flange portion that widens in an outwardly radial direction is formed at an upper end portion of the cylindrical holding portion of the housing, the flange portion having an inner circumferential surface partially overlapped with the cylindrical holding portion in an axial direction. Herein, the housing may be arranged on a jig in a state that the flange portion makes contact with the jig, and the stator and the attachment plate may be respectively press-fitted to the stator holding surface section and the attachment plate holding surface section.

In this manner, the stator and the attachment plate are press-fitted in a state that the flange portion remains in contact with a jig. Thus, it is possible for the flange portion to bear the press-fitting force applied to the housing. Furthermore, since the flange portion is partially overlapped with the cylindrical holding portion in an axial direction, it is also possible for the cylindrical holding portion to bear the press-fitting force applied to the housing. Therefore, it becomes possible to minimize the influence of the press-fitting force on the housing. This is particularly desirable in case where the housing has a reduced thickness.

In accordance with the present invention, it is possible to provide a motor in which an attachment plate is attached to a housing with increased precision, a disk drive apparatus equipped with the motor and a method for manufacturing the motor.

### BRIEF DESCRIPTION OF THE DRAWINGS

FIG. 1 is an axially-cut schematic section view showing a motor provided with a chucking device in accordance with one embodiment of the present invention.

FIG. 2 is a top plan view illustrating a chucking device in accordance with the present invention.

FIG. 3 is an axially-cut schematic section view showing a housing in accordance with the present invention.

FIG. 4 is an enlarged view of the portion indicated by a double-dotted chain line circle in FIG. 3.

FIG. 5 is a top view showing an attachment plate in accordance with the present invention.

FIG. 6 is an axially-cut schematic section view showing the attachment plate in accordance with the present invention.

FIG. 7 is an enlarged view of the portion indicated by a dot line circle in FIG. 6.

FIG. 8 is an axially-cut schematic section view showing a sleeve in accordance with the present invention.

FIG. 9 is a top plan view showing the sleeve in accordance with the present invention.

FIG. 10 is an axially-cut schematic section view illustrating the surroundings of the housing in the motor in accordance with the present invention.

FIG. 11 is an enlarged view of the portion indicated by a single-dotted chain line circle in FIG. 10, illustrating the relationship between an upper portion of the sleeve and an upper portion of the housing.

FIG. 12 is a top plan view illustrating the surroundings of the housing in the motor in accordance with the present invention.

FIG. 13 is an enlarged view of the portion indicated by a dot line circle in FIG. 10, illustrating the attachment relationship between the housing and the attachment plate.

FIG. 14 is a flow chart illustrating a manufacturing process of the motor in accordance with the present invention.

FIGS. 15A and 15B are axially-cut schematic section views depicting step S1 illustrated in FIG. 14.

FIG. 16 is an enlarged view illustrating a press-fitting structure of the stator and the housing depicted in FIGS. 15A and 15B.

FIGS. 17A and 17B are axially-cut schematic section views depicting step S2 illustrated in FIG. 14.

FIGS. 18A and 18B are axially-cut schematic section views depicting step S3 illustrated in FIG. 14.

FIG. 19 is a schematic view showing a sizing bar illustrated in FIGS. 18A and 18B.

FIGS. 20A and 20B are axially-cut schematic section views depicting step S4 illustrated in FIG. 14.

FIGS. 21A and 21B are axially-cut schematic section views depicting step S5 illustrated in FIG. 14.

FIG. 22 is an axially-cut schematic section view showing a motor in accordance with another embodiment of the present invention.

FIG. 23 is an axially-cut schematic section view showing a disk drive apparatus equipped with the motor in accordance with the present invention.

FIG. 24 an axially-cut schematic section view showing a conventional motor.

### DETAILED DESCRIPTION OF THE PREFERRED EMBODIMENTS

(Overall Structure of a Motor)

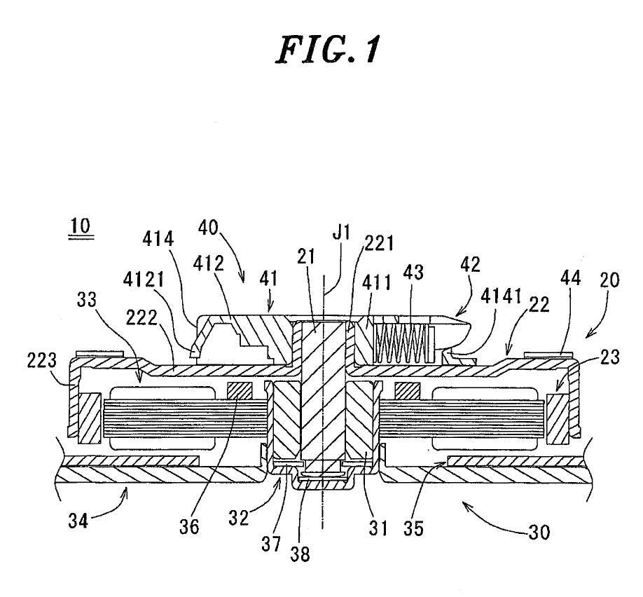

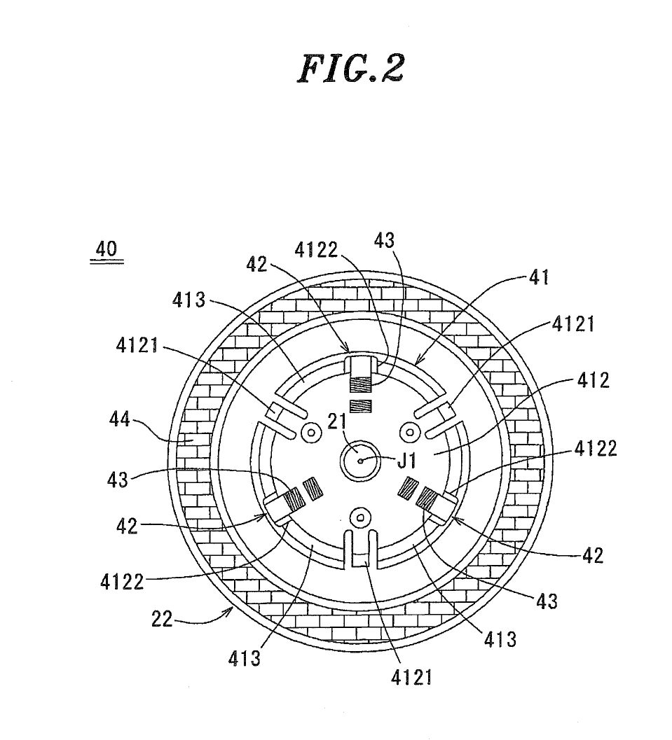

An overall structure of a motor provided with a chucking device in accordance with the present invention will now be described with reference to FIGS. 1 and 2. FIG. 1 is an axially-cut schematic section view showing a motor in accordance with one embodiment of the present invention. FIG. 2 is a top plan view illustrating a chucking device 40. In describing the present embodiment, the side on which a chucking device 40 is arranged will be referred to as an upper side and the side on which an attachment plate 34 is arranged will be referred to as a lower side, for the purpose of convenience. The terms “upper” and “lower” do not necessarily coincide with the gravitational direction.

Referring to FIG. 1, a motor 10 includes a rotating body 20 having a shaft 21 rotatable about a center axis J1; a fixed body 30 having a sleeve 31 for rotatably supporting the rotating body 20; and a chucking device 40 attached to an upper portion of the rotating body 20 for holding a disk (not shown) having a central opening portion in a removable manner.

First, description will be made regarding the rotating body 20.

The rotating body 20 includes a rotatable shaft 21 arranged coaxially with the center axis J1; a rotor holder 22 fixed to an axial upper portion of the shaft 21; and a substantially annular rotor magnet 23 fixedly secured to the rotor holder 22 for rotating together with the shaft 21 as a united body.

The rotor holder 22 includes a substantially cylindrical shaft-fixed portion 221 having an inner circumferential surface fixed to an outer circumferential surface of the shaft 21; a cover portion 222 extending radially outwardly from the shaft-fixed portion 221 over the entire circumference of the latter; and a cylinder portion 223 extending in an axially downward direction from an outer circumferential edge of the cover portion 222. The rotor magnet 23 is fixed to an inner circumferential surface of the cylinder portion 223 by means of an adhesive agent.

Next, description will be made regarding the fixed body 30.

The fixed body 30 includes a substantially cylindrical sleeve 31 having an inner circumferential surface for rotatably supporting the shaft 21 in a radial direction; a substantially cylindrical housing 32 for holding an outer circumferential surface of the sleeve 31; a stator 33 held against an outer circumferential surface of the housing 32; an attachment plate 34 arranged axially downwardly of the stator 33 and held against an outer circumferential surface of the housing 32; and a circuit board 35 having an aperture that is substantially coaxial with the center axis is arranged on the upper surface of the attachment plate 34, an inner diameter of the aperture being greater than an outer diameter of the attachment portion.

A substantially annular preloaded magnet 36 is arranged on an inner-circumference-side upper surface of the stator 33 to axially face a lower surface of the cover portion 222 of the holder 22. Furthermore, a substantially disk-like washer 37 is arranged to axially face a bottom surface of the sleeve 31. The washer 37 engages with the shaft 21, thereby securing a removal-proof state. In addition, a substantially disk-like thrust plate 38 is arranged to axially face a bottom surface of the shaft 21. The shaft 21 is rotatably supported by means of the thrust plate 38 in an axial direction.

Next, the chucking device 40 will be described with reference to FIGS. 1 and 2.

The chucking device 40 includes a central case 41 arranged inwardly of an inner circumferential surface of a central opening portion of a disk for bringing the center of the central opening portion of the disk into alignment with the center axis J1; a claw member 42 (three claw members in the example of FIG. 2) partially received in the central case 41 in a radially movable manner for holding the disk in place; a resilient member 43 (a coil spring in the present embodiment) for radially outwardly biasing the claw member 42; and a disk support portion 44 arranged radially outwardly of the central case 41 and adapted to make contact with a lower surface of the disk.

The central case 41 includes a base portion 411 fixed to an outer circumferential surface of the shaft-fixed portion 221 of the rotor holder 22; a cover portion 412 axially outwardly extending from an axial upper portion of the base portion 411 over the entire circumference of the latter; a guide portion 413 having a slanting surface whose diameter is increased from the cover portion 412 toward the lower side; and a cylinder portion 414 axially downwardly extending from the guide portion 413.

The central case 41 has an aligning claw 4121 extending from a radial outer end of the cover portion 412 through the guide portion 413 and the cylinder portion 414. The aligning claw 4121 serves to bring the center of the central opening portion of the disk into alignment with the center axis J1 (the center of the central case 41) by making contact with the inner circumferential surface of the central opening portion of the disk.

The central case 41 has an opening portion 4122 (three opening portions in the present invention as shown in FIG. 2) formed by cutting out the guide portion 413 and the cylinder portion 414. A portion of the radial inner portion of the claw member 42 is situated within the opening portion 4122. The resilient member 43 is inserted into a radially-oriented gap between the claw member 42 and the base portion 411 of the central case 41 in a compressed state.

In a portion of the cylinder portion 414 circumferentially corresponding to the claw member 42, a rest portion 4141 is formed as a united body with the cylinder portion 414. The rest portion 4141 makes contact with the claw member 42 and guides radial inward movement of the claw member 42.

(Shape of the Housing 32)

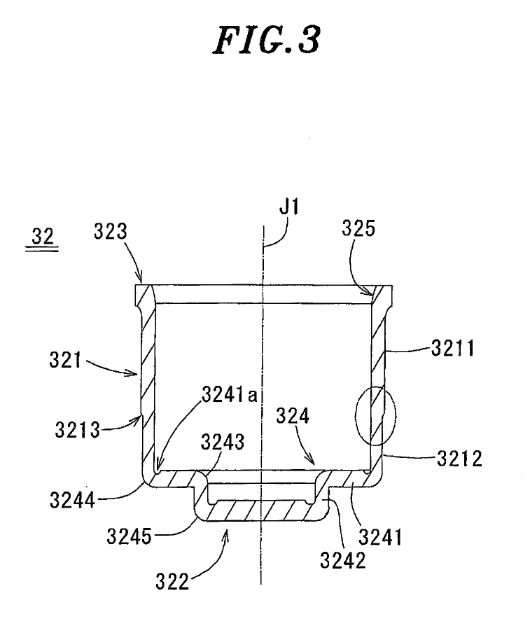

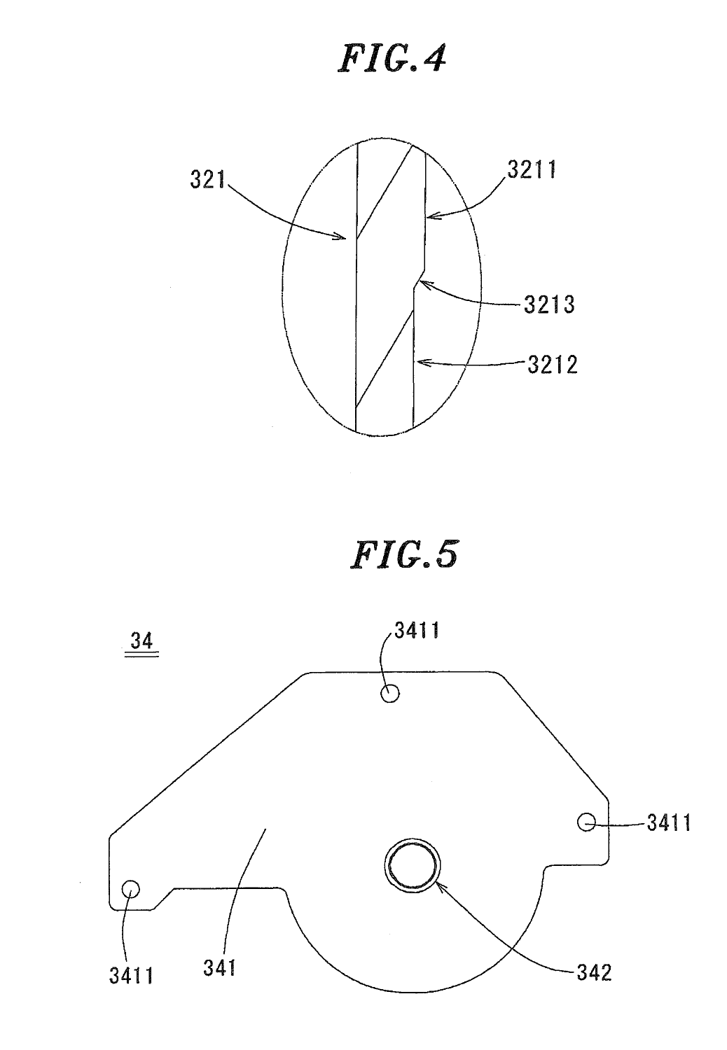

Next, the shape of the housing 32 will be described with reference to FIGS. 3 and 4. FIG. 3 is an axially-cut schematic section view showing the housing 32 in accordance with the present invention. FIG. 4 is an enlarged view of the portion indicated by a double-dotted chain line circle in FIG. 3.

In FIG. 3, the housing 32 is made of a press-formed metal plate. The housing 32 includes a cylindrical holding portion 321 extending in an axial direction; and a bottom portion 322 that closes off a lower end opening of the cylindrical holding portion 321. At an upper end opening of the cylindrical holding portion 321 is formed a flange portion 323 extending in a radially outward direction over the entire circumference thereof.

A step portion 324 is formed between the cylindrical holding portion 321 and the bottom portion 322 of the housing 32. The step portion 324 includes an inner extension portion 3241 extending in a radially inward direction from the cylindrical holding portion 321; an inner cylinder portion 3242 extending between the inner extension portion 3241 and the bottom portion 322; and a first curved portion 3243 for interconnecting the inner extension portion 3241 and the inner cylinder portion 3242. The inner extension portion 3241 extends at a right angle with respect to the cylindrical holding portion 321. A downwardly recessed annular groove portion 3241a is formed between an outer circumferential edge of an upper surface of the inner extension portion 3241 and an inner circumferential surface of the cylindrical holding portion 321.

The cylindrical holding portion 321 is connected to the inner extension portion 3241 via a second curved portion 3244. The bottom portion 322 is connected to the inner cylinder portion 3242 via a third curved portion 3245.

Referring to FIG. 4, the cylindrical holding portion 321 has an outer circumferential surface which includes a stator holding surface section 3211 to which the stator 33 is attached, and a attachment plate holding surface section 3212 to which the attachment plate 34 is attached. The attachment plate holding surface section 3212 is arranged axially below the stator holding surface section 3211. The stator holding surface section 3211 has an outer diameter greater than that of the attachment plate holding surface section 3212. A housing slanting surface 3213 whose diameter increases along an axially upward direction is formed in an axial gap between the stator holding surface section 3211 and the attachment plate holding surface section 3212.

The cylindrical holding portion 321 has an inner circumferential surface formed of a cylindrical surface whose inner diameter remains constant along an axial direction. The inner circumferential surface of the cylindrical holding portion 321 is radially overlapped with the entire axial length of the stator holding surface section 3211 and an upper part of the attachment plate holding surface section 3212.

A curved surface portion 325 whose diameter increases along an axially upward direction is formed to extend from an upper end portion of the inner circumferential surface of the cylindrical holding portion 321 to a top surface of the flange portion 323.

The cylindrical holding portion 321 and the bottom portion 322 are formed of a single metal plate. This eliminates a member-to-member joint which would otherwise exist if the cylindrical holding portion and the bottom portion are formed as separate members. Therefore, it is possible to prevent oil of the sleeve from leaking through the joint. In addition, if the cylindrical holding portion and the bottom portion are formed as separate members, the number of parts will be increased, and the number of manufacturing steps will also be increased because a step of fixing the cylindrical holding portion to the bottom portion will become necessary. This increases the manufacturing cost. In contrast, by forming the cylindrical holding portion and the bottom portion as a single body, it is possible to reduce the number of parts and the number of manufacturing steps as compared to the case that they are formed as separate members. This helps reduce the cost involved in manufacturing the motor.

(Shape of the Attachment Plate 34)

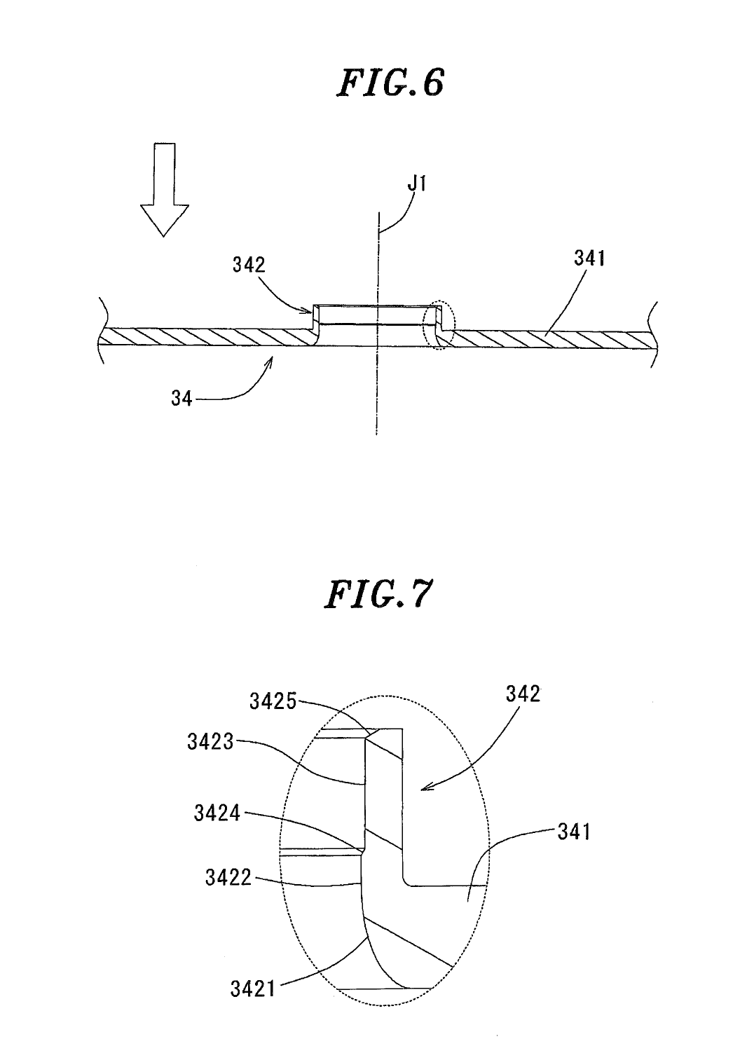

Next, the shape of the attachment plate 34 will be described with reference to FIGS. 5 to 7. FIG. 5 is a top view showing the attachment plate 34. FIG. 6 is an axially-cut schematic section view of the attachment plate 34. FIG. 7 is an enlarged view of the portion indicated by a dot line circle in FIG. 6.

Referring to FIG. 5, the attachment plate 34 is of a plate shape formed by pressing a metal plate. The attachment plate 34 includes a plate portion 341 to which the circuit board 35 is fixed via an insulating layer (or an insulating member); and an attachment portion 342 having an inner circumferential surface to which the attachment plate holding surface section 3212 of the housing 32 is fixed.

A plurality of attachment holes 3411 (three attachment holes in the illustrated example) for attaching the motor 10 to other devices (not shown) are formed in the plate portion 341.

Referring to FIG. 6, the attachment plate 34 is punched by a press machine (not shown) in the direction indicated by an arrow. Thus, a sagging portion is formed in the peripheral edge of an upper surface of the attachment plate 34. Furthermore, a burr is formed in the peripheral edge of a lower surface of the attachment plate 34.

The attachment portion 342 of the attachment plate 34 is formed by axially burring a portion of the attachment plate 34 into a substantially cylindrical shape. Thus, the attachment portion 342 has a thickness smaller than that of the plate portion 341. In the present embodiment, the thickness of the attachment portion 342 is about 0.6 mm, whereas that of the plate portion 341 is about 0.8 mm.

Referring to FIG. 7, the attachment portion 342 includes a curved portion 3421 extending from the plate portion 341 in a bent shape; an axially-extending cylindrical fitting portion 3422 formed axially above an upper edge of the curved portion 3421; and an increased diameter portion 3423 formed axially above the fitting portion 3422, whose inner diameter is greater than that of the fitting portion 3422. A first slanting surface 3424 whose diameter increases along an axially upward direction is formed between the inner circumferential surface of the increased diameter portion 3423 and a part of the inner circumferential surface of the attachment portion 342 that is in contact with the attachment plate holding surface section 3212. Further, a second slanting surface 3425 whose diameter increases along an axially upward direction is formed at an upper edge of the inner circumferential surface of the increased diameter portion 3423.

The attachment portion 342 has an outer circumferential surface whose diameter remains substantially constant along an axial direction. The outer circumferential surface of the attachment portion 342 is connected to an upper surface of the plate portion 341 via a curved surface.

(Shape of the Sleeve 31)

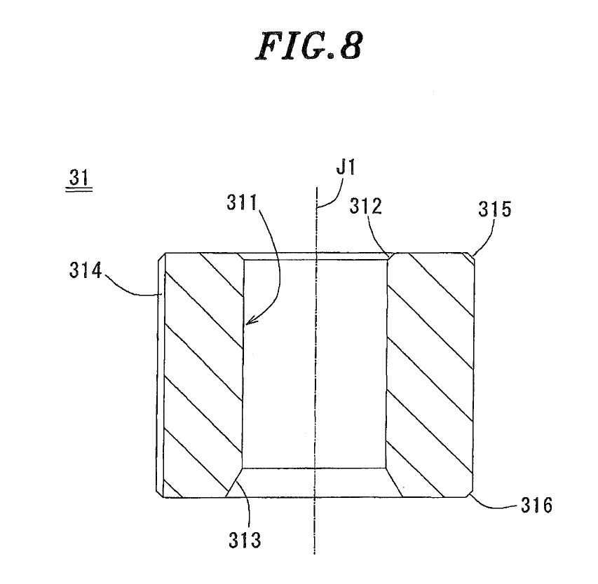

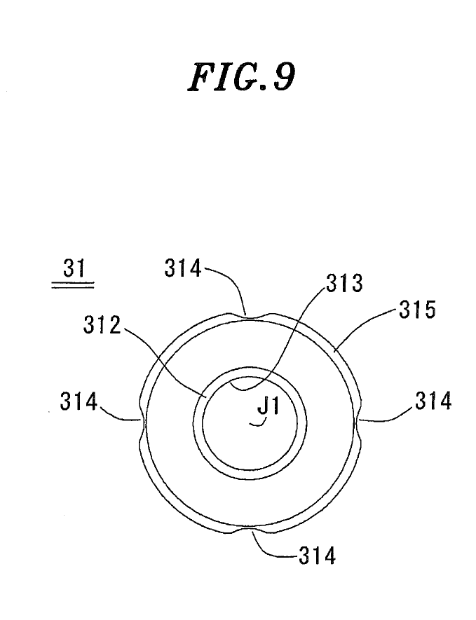

Next, the shape of the sleeve 31 will be described with reference to FIGS. 8 and 9. FIG. 8 is an axially-cut schematic section view showing the sleeve 31. FIG. 9 is a top plan view of the sleeve 31.

Referring to FIG. 8, the sleeve 31 is an oil-impregnated slide bearing formed by impregnating sintered metal with oil. The sleeve 31 has an inner circumferential surface 311 whose diameter remains substantially constant along an axial direction. The inner circumferential surface 311 is adapted to bear the outer circumferential surface of the shaft 21, thereby rotatably supporting the shaft 21 in a radial direction.

An upper inner circumferential slanting surface 312 whose diameter increases along an axially upward direction is formed in an axial upper edge of the inner circumferential surface 311 of the sleeve 31. A lower inner circumferential slanting surface 313 whose diameter increases along an axially downward direction is formed in an axial lower edge of the inner circumferential surface 311 of the sleeve 31.

A plurality of communication grooves 314 recessed toward the center axis J1 in a groove shape are formed on the outer circumferential surface of the sleeve 31 (four communication grooves, for example, are equidistantly arranged at an interval of 90° in the illustrated example). The upper and bottom surfaces of the sleeve 31 communicate with each other via these communication channels 314.

An upper outer circumferential slanting surface 315 whose diameter decreases along an axially upward direction is formed at an upper edge of the outer circumferential surface of the sleeve 31. A lower outer circumferential slanting surface 316 whose diameter decreases along an axially downward direction is formed at a lower edge of the outer circumferential surface of the sleeve 31.

Herein, the lower inner circumferential slanting surface 313 has a size greater than that of the upper inner circumferential slanting surface 312, the upper outer circumferential slanting surface 315 and the lower outer circumferential slanting surface 316. The lower inner circumferential slanting surface 313 makes an acute angle with respect to the center axis J1, which is smaller than the acute angle that the slanting surfaces 312, 315 and 316 make relative to the center axis J1.

(Surrounding Structure of the Housing)

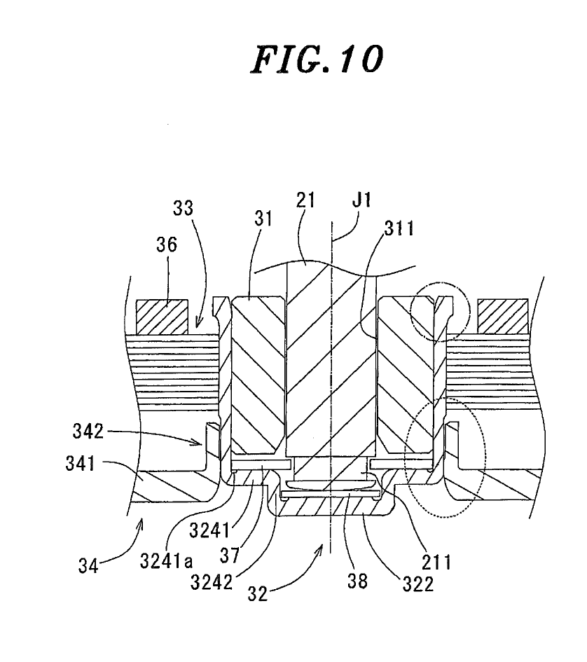

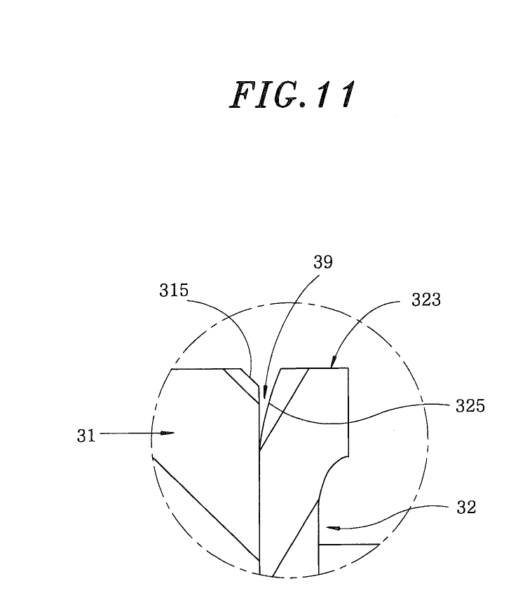

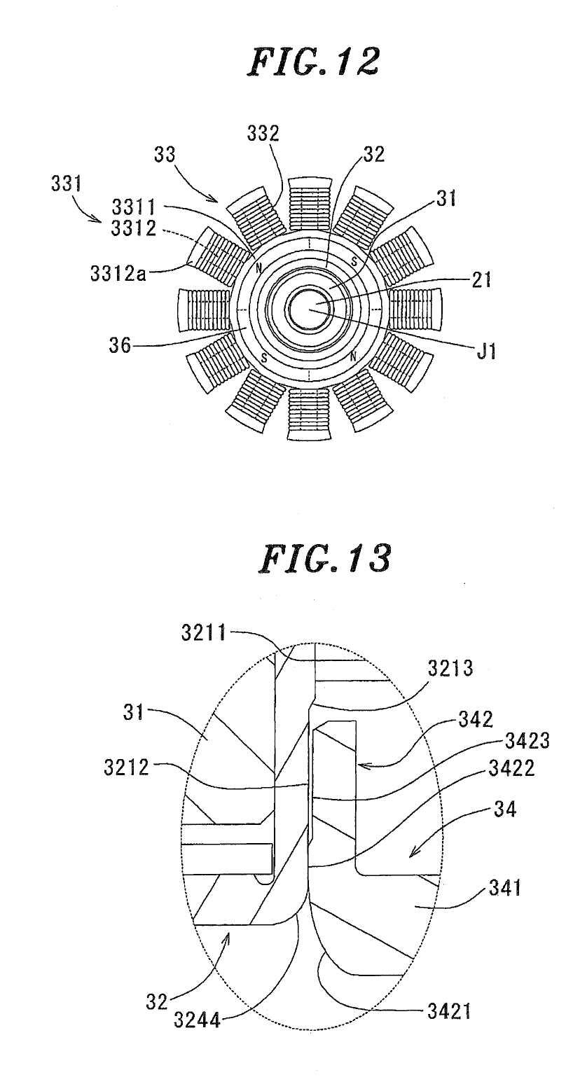

Next, the surrounding structure of the housing 32 in the motor 10 will be described with reference to FIGS. 10 to 13. FIG. 10 is an axially-cut schematic section view illustrating the surroundings of the housing 32 in the motor 10 in accordance with the present invention. FIG. 11 is an enlarged view of the portion indicated by a single-dotted chain line circle in FIG. 10, illustrating the relationship between the upper portion of the sleeve 31 and the upper portion of the housing 32. FIG. 12 is a top plan view illustrating the surroundings of the housing 32 in the motor 10 in accordance with the present invention. FIG. 13 is an enlarged view of the portion indicated by a dot line circle in FIG. 10, illustrating the attachment relationship between lower portion of the cylindrical holding portion 321 of the housing and the attachment portion 342 of the attachment plate 34.

Referring to FIG. 10, the outer circumferential surface of the sleeve 31 is press-fitted to the inner circumferential surface of the cylindrical holding portion 321 of the housing 32. The top surface of the sleeve 31 has the same axial height as that of the upper surface of the flange portion 323 of the housing 32. The axial length over which the outer circumferential surface of the sleeve 31 is press-fitted to the inner circumferential surface of the cylindrical holding portion 321 of the housing 32 is about 4 mm.

An axial gap exists between the bottom surface of the sleeve 31 and the upper surface of the inner extension portion 3241 of the housing 32. The washer 37 is arranged on the upper surface of the inner extension portion 3241. The shaft 21 is arranged to radially face an inner circumferential surface of the washer 37.

The shaft 21 has a reduced diameter portion 211 formed at a location where the shaft 21 faces the washer 37. The reduced diameter portion 211 has an outer diameter smaller than that of other portion of the shaft 21 that radially faces the inner circumferential surface 311 of the sleeve 31. The reduced diameter portion 211 has an axial length greater than the axial thickness of the washer 37. The radial distance between the outer circumferential surface of the reduced diameter portion 211 and the inner circumferential surface of the washer 37 is set greater than the radial distance between the inner circumferential surface of the cylindrical holding portion 321 and the outer circumferential surface of the washer 37.

This structure makes it possible to prevent the washer 37 and the shaft 21 from making contact with each other during rotation of the motor, except the case that the shaft 21 is moved in an axial direction. Thus, it is possible to avoid getting the washer 37 cut, which might otherwise occur when the shaft 21 makes contact with the washer 37. As a result, it becomes possible to prevent powdery cutting chips of the washer 37 from entering between the shaft 21 and the sleeve 31. This, in turn, makes it possible to keep the shaft 21 and the sleeve 31 from being stuck together in a heated state.

Due to the presence of the annular groove portion 3241a between the outer circumferential edge of the inner extension portion 3241 and the inner circumferential surface of the cylindrical holding portion 321, the upper surface of the inner extension portion 3241 and the inner circumferential surface of the cylindrical holding portion 321 are not interconnected via a curved surface. This structure makes it possible to position the outer circumferential surface of the washer 37 closer to the inner circumferential surface of the cylindrical holding portion 321. Therefore, it is possible to restrict radial movement of the washer 37 strictly. Further, this structure also helps to arrange the washer 37 perpendicularly to the cylindrical holding portion 321, thereby preventing the washer 37 from being positioned obliquely.

The thrust plate 38, arranged on the upper surface of the bottom portion 322, is made of a resin material that exhibits superior slidability and wear resistance. Further, the thrust plate 38 has an outer circumferential surface lying near the inner circumferential surface of the inner cylinder portion 3242 in a radial direction. The bottom surface of the shaft 21, which makes contact with an upper surface of the thrust plate 38, is formed in a shape approximately same as a truncated sphere.

Referring to FIG. 12, the stator 33 attached to the stator holding surface section 3211 of the outer circumferential surface of the cylindrical holding portion 321 includes a stator core 331 having a substantially annular core-back portion 3311 having an inner circumferential surface fitted to the stator holding surface section 3211, and a plurality of tooth portions 3312 radially outwardly extending from the core-back portion 3311; and a coil 332 formed by winding an electric wire around the tooth portions 3312 in plural layers through an insulating layer (insulating member) not shown in the drawings.

The stator core 331 is formed by arranging a plurality of thin magnetic stator laminations one above another in an axial direction. The tooth portions 3312 of the stator core 331 extend from an outer circumferential surface of the core-back portion 3311 in a circumferentially spaced-apart relationship (the number of the tooth portions 3312 is twelve in the illustrated example). On the radial outer side of each of the tooth portions 3312, there is formed an umbrella portion 3312a extending in the opposite circumferential directions from each of the tooth portions 3312. The umbrella portion 3312a has an outer circumferential surface that radially faces the inner circumferential surface of the rotor magnet 23 with a gap left therebetween.

The substantially annular preloaded magnet 36 is fixed to the top surface of the core-back portion 3311 of the stator 33. The preloaded magnet 36 is magnetized with four poles along the circumferential direction thereof. The preloaded magnet 36 has an upper surface that axially faces the lower surface of the cover portion 222 of the rotor holder 22. The preloaded magnet 36 is able to reduce minute axial vibration of the rotor holder 22 by axially downwardly attracting the rotor holder 22.

Referring back to FIG. 11, an upper part of the outer circumferential surface of the sleeve 31 and the upper outer circumferential slanting surface 315 of the sleeve 31 are formed to radially face the inner circumferential surface of the curved surface portion 325 of the cylindrical holding portion 321 with an annular gap 39 left therebetween. The annular gap 39 is able to collect the oil exuding from the top surface of the sleeve 31. This ensures that the oil exuding from the top surface of the sleeve 31 refrains from leaking out radially outwardly of the housing 32, thereby prolonging the life time of the sleeve 31 as a bearing.

Further, formation of the curved surface portion 325 helps increase the volume of the gap 39. The volume of the gap 39 can be further increased by forming the upper outer circumferential slanting surface 315 in a radially inward direction relative to the curved surface portion 325. Therefore, it is possible to increase the quantity of oil that can be received in the gap 39, which suppress an overflow of the oil in the gap 39. As a result, it becomes possible to further prolong the life time of the sleeve 31 as a bearing.

Referring to FIG. 13, the attachment portion 342 of the attachment plate 34 is attached to the attachment plate holding surface section 3212 of the outer circumferential surface of the cylindrical holding portion 321 of the housing 32. The fitting portion 3422 of the attachment portion 342 is press-fitted to the attachment plate holding surface section 3212. A radially-oriented gap is formed between the surface of the attachment plate holding surface section 3212, which lies axially above a portion that makes contact with the fitting surface 3422, and the inner circumferential surface of the increased diameter portion 3423. An adhesive agent is filled in the radially-oriented gap to enhance the fixing strength between the attachment plate holding surface section 3212 and the attachment portion 342.

Herein, a portion of the attachment plate holding surface section 3212 that makes contact with the fitting surface 3422 is formed to be the most rigid region in the attachment plate holding surface section 3212, considering that it lies in close proximity to the second curved portion 3244. Thus, it is possible to minimize radially inward-directional deformation of the attachment plate holding surface section 3212 even when the fitting surface 3422 is press-fitted to the attachment plate holding surface section 3212. The fitting surface 3422 lies near the curved portion 3421. In consideration of this, the fitting surface 3422 is formed to be the most rigid portion in the attachment portion 342. Thus, it is possible to minimize radially outward-directional deformation of the fitting surface 3422 even when the fitting surface 3422 is press-fitted to the attachment plate holding surface section 3212.

Forming the attachment portion 342 by burring has an advantage in that the machining work can be performed in a cost-effective manner. However, in this case, the thickness and rigidity of the attachment portion 342 are decreased. Further, if the attachment portion 342 is attached to the cylindrical holding portion 321 at a region of reduced rigidity, there is posed a problem in that the attachment portion 342 undergoes deformation. This makes it difficult to attach the attachment plate 34 to the cylindrical holding portion 321 with increased precision. In other words, it is difficult to attach the plate portion 341 of the attachment plate 34 at a right angle relative to the cylindrical holding portion 321.

However, in the present embodiment, the fitting surface 3422 is formed in close proximity to the curved portion 3421. Thus, it becomes possible to increase the rigidity of the fitting surface 3422 and consequently to suppress deformation of the attachment portion 342. This allows to attach the attachment plate 34 to the cylindrical holding portion 321 with increased precision. In other words, the plate portion 341 of the attachment plate 34 can be attached at a right angle relative to the cylindrical holding portion 321.

Since a portion of the attachment plate holding surface section 3212 to which the fitting surface 3422 is press-fitted lies in close proximity to the second curved portion 3244, it is possible to increase rigidity of the attachment plate holding surface section 3212 and consequently to restrain deformation thereof. In particular, since the attachment plate holding surface section 3212 is the lowermost region of the cylindrical holding portion 321, the deformation thereof heavily affects the shape of the cylindrical holding portion 321. Therefore, it is desirable to press-fit a portion of the attachment plate holding surface section 3212 nearer to the second curved portion 3244.

(Method for Manufacturing the Motor)

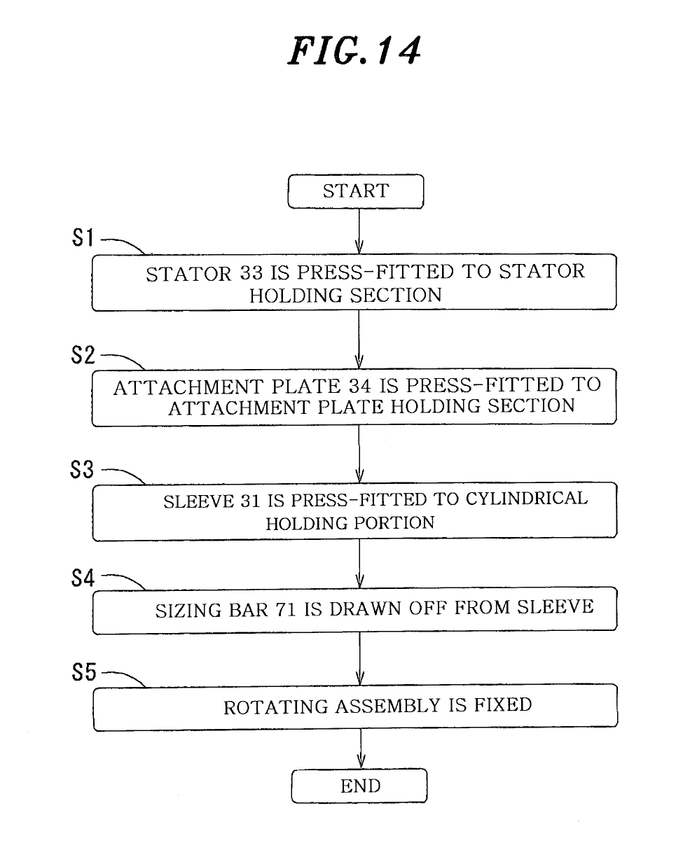

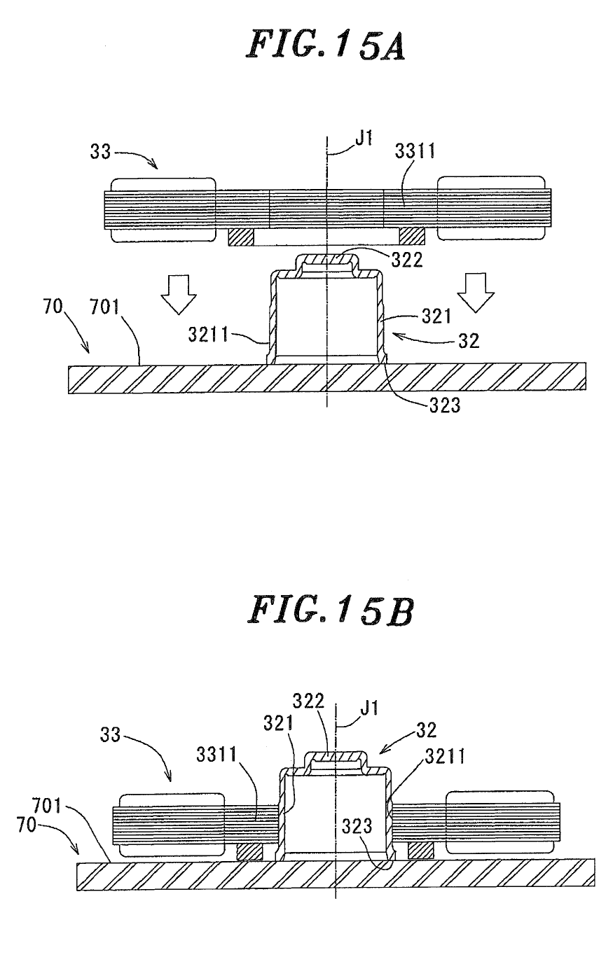

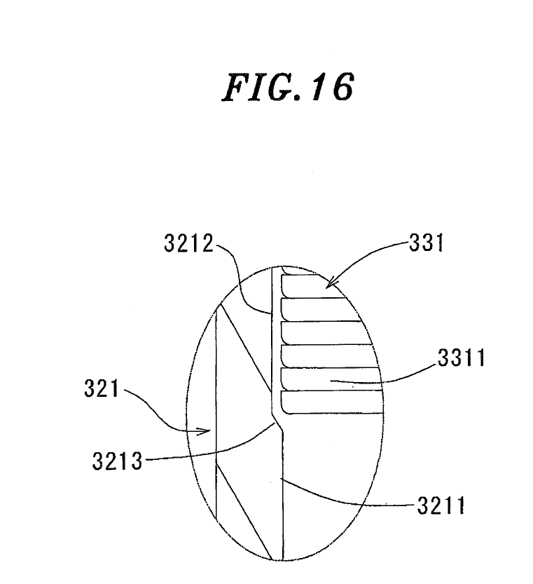

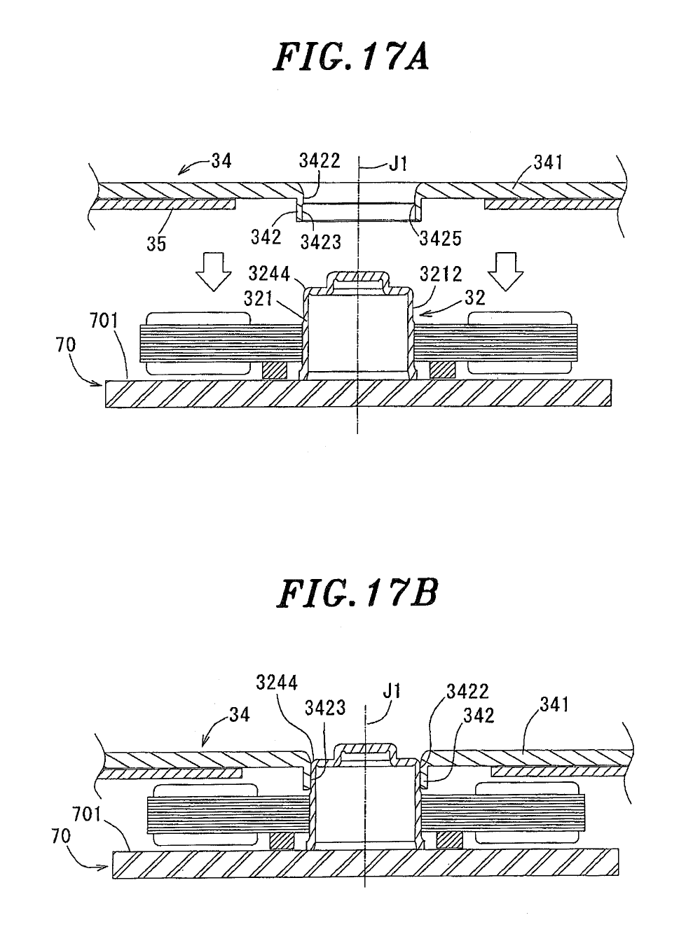

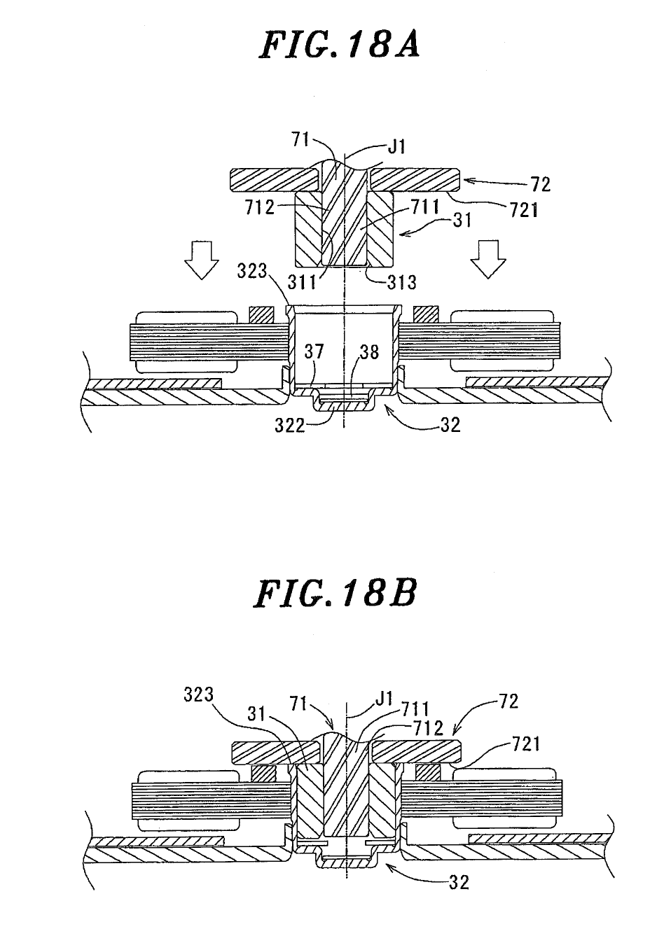

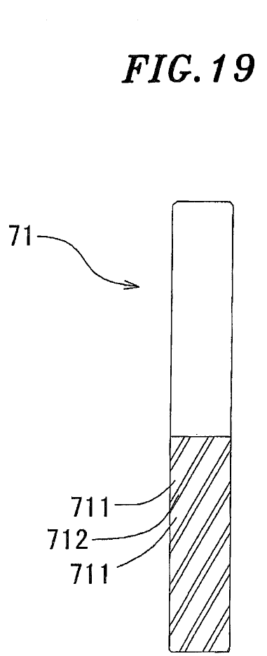

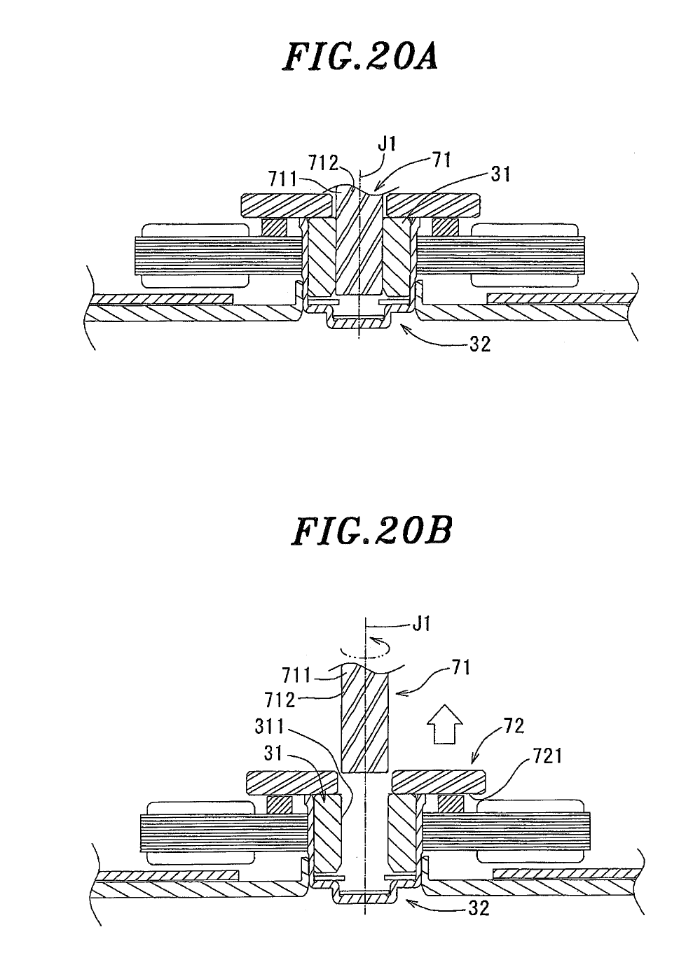

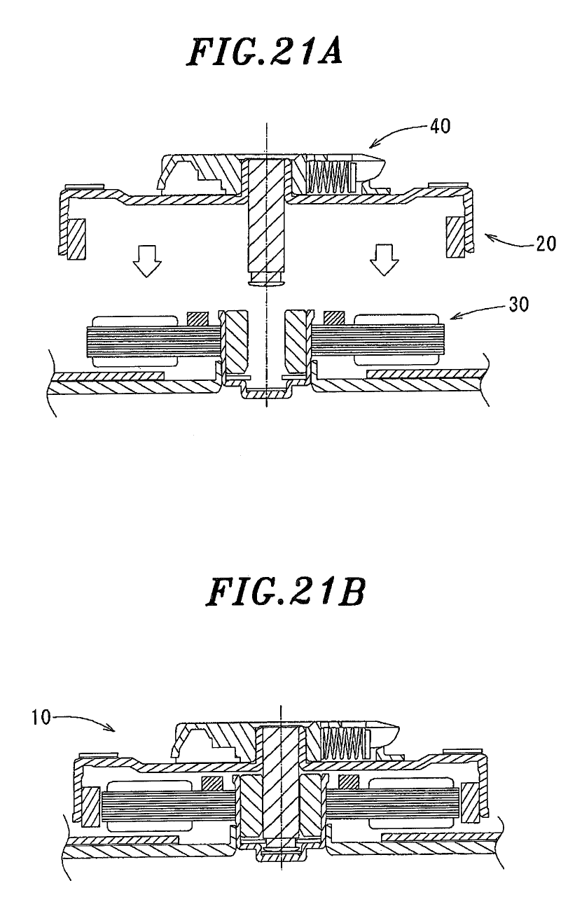

Next, a method for manufacturing the motor in accordance with the present invention will be described with reference to FIGS. 14 to 21. FIG. 14 is a flow chart illustrating a manufacturing process of the motor in accordance with the present invention. FIGS. 15A and 15B are axially-cut schematic section views depicting step S1 illustrated in FIG. 14. FIG. 16 is an enlarged view illustrating a press-fitting structure of the stator 33 and the cylindrical holding portion 321 of the housing 32 depicted in FIGS. 15A and 15B. FIGS. 17A and 17B are axially-cut schematic section views depicting step S2 illustrated in FIG. 14. FIGS. 18A and 18B are axially-cut schematic section views depicting step S3 illustrated in FIG. 14. FIG. 19 is a schematic view showing a sizing bar. FIGS. 20A and 20B are axially-cut schematic section views depicting step S4 illustrated in FIG. 14. FIGS. 21A and 21B are axially-cut schematic section views depicting step S5 illustrated in FIG. 14. The figures that depict the individual steps are divided into a pre-execution state (the state depicted in those with suffix “A”) and a post-execution state (the state depicted in those with suffix Referring to FIGS. 15A and 15B, the inner circumferential surface of the core-back portion 3311 (the region lying radially inward of a dot line in FIG. 15) of the stator 33 is first press-fitted to the stator holding surface section 3211 of the cylindrical holding portion 321 of the housing 32 (step S1 in FIG. 14). At this time, the stator 33 is attached to the housing 32 from the side of the bottom portion 322 in a state that the upper surface of the flange portion 323 of the housing 32 is placed on a planar surface 701 of a first jig 70 arranged perpendicularly to the center axis J1. This structure ensures that the force acting at the time of press-fitting the stator 33 to the housing 32 is absorbed by the flange portion 323 and then applied to the cylindrical holding portion 321.

In a hypothetical case that the stator 33 is attached to the housing 32 from the side opposite to the bottom portion 322 in a state that a jig is in contact with the bottom portion 322, the force acting at the time of press-fitting the stator 33 to the housing 32 would be applied to the bottom portion 322. In this case, if the bottom portion 322 has a reduced thickness (e.g., a thickness of about 0.5 mm), there is a possibility that the bottom portion 322 may be deformed, e.g., in an axial direction, by the force acting at the time of press-fitting the stator 33 to the housing 32. In the present invention, however, the force acting at the time of press-fitting the stator 33 to the housing 32 is absorbed by the flange portion 323. For this reason, the cylindrical holding portion 321 has a strength great enough to resist an axially acting force, which makes it possible to restrain deformation of the flange portion 323 and the cylindrical holding portion 321.

Seeing that the inner circumferential surface of the core-back portion 3311 of the stator core 331 has an inner diameter greater than the outer diameter of the attachment plate holding surface section 3212, it is possible to prevent the inner circumferential surface of the core-back portion 3311 from making contact with the attachment plate holding surface section 3212 with a force great enough to deform the same. Therefore, even while the stator 33 is being press-fitted to the attachment plate holding surface section 3212 of the cylindrical holding portion 321, it is possible to prevent the attachment plate holding surface section 3212 from being deformed by the stator 33.

An adhesive agent is applied on the axially lower region of the stator holding surface section 3211. Thus, the inner circumferential surface of the core-back portion 3311 of the stator 33 is press-fitted in such a manner that the adhesive agent is spread mainly in an axially upward direction. This makes it possible to increase the fixing strength between the housing 32 and the stator 33. Further, the adhesive agent serves to solidify a burr generated in the press-fitting process. This makes it possible to prevent the burr from entering between the outer circumferential surface of the shaft 21 and the inner circumferential surface 311 of the sleeve 31, which might otherwise cause the shaft 21 and the sleeve 31 to be stuck together in a heated state. In this manner, it is possible to provide a highly reliable motor.

Referring to FIG. 16, the stator core 331 includes a plurality of thin plates punched by press working and laminated in an axial direction. In the peripheral edge of each of the thin plates, a sagging surface is formed on the punching side due to the punching during the press working, and a burr-formed surface is formed on the opposite side to the sagging surface. Herein, the stator core 331 is fabricated by laminating the thin plates such that the sagging surface becomes an upper surface.

When the inner circumferential surface of the core-back portion 3311 of the stator core 331 is press-fitted to the stator holding surface section 3211, the sagging surface formed on the upper edge of the inner circumferential surface of the core-back portion 3311 makes contact with the housing slanting surface 3213 formed axially between the stator holding surface section 3211 and the attachment plate holding surface section 3212. This allows the core-back portion 3311 to be smoothly guided toward the stator holding surface section 3211.

Therefore, it is possible to bring the axis of the stator holding surface section 3211 of the cylindrical holding portion 321 of the housing 32 into alignment with the axis of the core-back portion 3311 of the stator 33 with increased precision. This helps reduce an unbalanced load that would be applied to the stator holding surface section 3211 when the axis of the stator holding surface section 3211 is out of alignment with the axis of the core-back portion 3311. Consequently, it becomes possible to prevent a portion of the circumferential region of the cylindrical holding portion 321 from being deformed severely.

Referring next to FIGS. 17A and 17B, the fitting surface 3422 of the attachment portion 342 of the attachment plate 34 is press-fitted to the attachment plate holding surface section 3212 of the cylindrical holding portion 321 of the housing 32 in a state that the upper surface of the flange portion 323 of the housing 32 is brought into contact with the planar surface 701 of the first jig 70 (step S2 in FIG. 14). In this case, the force acting at the time of press-fitting the attachment plate 34 to the housing 32 is imparted to the cylindrical holding portion 321 as is the case in step S1. This makes it possible to restrain deformation of the flange portion 323 and the cylindrical holding portion 321.

Herein, since the second slanting surface 3425 is formed in the upper end portion of the inner circumferential surface of the attachment portion 342, it is possible to bring the radial center of the inner circumferential surface of the attachment portion 342 into alignment with the radial center of the attachment plate holding surface section 3212 with increased precision. This helps reduce an unbalanced load that would be applied to the attachment plate holding surface section 3212 if the radial center of the inner circumferential surface of the attachment portion 342 is out of alignment with the radial center of the attachment plate holding surface section 3212. Consequently, it becomes possible to prevent the circumferential region of the attachment plate holding surface section 3212 from being deformed severely.

Since the second curved portion 3244 is formed axially below the attachment plate holding surface section 3212, it is possible to more smoothly guide the attachment portion 342 toward the attachment plate holding surface section 3212. In other words, since the second curved portion 3244 and the second slanting surface 3425 make contact with each other, the second slanting surface 3425 is moved toward the attachment plate holding surface section 3212 along the second curved portion 3244.

Owing to the fact that the increased diameter portion 3423 is extended from the second slanting surface 3425, the attachment portion 342 guided by the second slanting surface 3425 comes into an insertion state (a gap-fitted state) in which the increased diameter portion 3423 of the attachment portion 342 is fitted to the attachment plate holding surface section 3212. This makes it possible to more accurately bring the axis of the inner circumferential surface of the attachment portion 342 into alignment with the axis of the attachment plate holding surface section 3212.

Therefore, it is possible to further reduce the unbalanced load applied to the attachment plate holding surface section 3212 and to further restrain deformation of the portion of the circumferential region of the attachment plate holding surface section 3212. As a result, it becomes possible to attach the attachment plate 34 to the housing 32 with increased precision. In other words, the plate portion 341 of the attachment plate 34 can be made perpendicular to the cylindrical holding portion 321 of the housing 32 in a highly accurate manner.

An adhesive agent is filled between the outer circumferential surface of the attachment plate holding surface section 3212 and the inner circumferential surface of the increased diameter portion 3423.

Referring next to FIGS. 18A and 18B, the sleeve 31 is press-fitted to the inner circumferential surface of the cylindrical holding portion 321 of the housing 32 (step S3 in FIG. 14). Herein, the washer 37 is pre-arranged on the upper surface of the inner extension portion 3241 of the housing 32. Furthermore, the thrust plate 38 is pre-arranged on the upper surface of the bottom portion 322. Further, in case of FIGS. 20A and 20B, it is desirable that the gravitational direction is oriented from the attachment plate 34 toward the stator 33.

The sizing bar 71 is inserted into the inner circumferential surface 311 of the sleeve 31, in which state the sleeve 31 is press-fitted to the housing 32. The lower end portion of the sizing bar 71 is positioned axially above the bottom surface of the sleeve 31 but axially below the upper edge of the lower inner circumferential slanting surface 313. In other words, the lower end portion of the sizing bar 71 is arranged at an axial location within the extent of the axial length of the lower inner circumferential slanting surface 313. This makes it possible to keep the sizing bar 71 from making contact with the washer 37.

Therefore, it is possible to eliminate the likelihood that the powdery cutting chips, which might otherwise be generated due to the contact between the washer 37 and the sizing bar 71, enter between the shaft 21 and the inner circumferential surface 311 of the sleeve 31. Thus, the shaft 21 and the sleeve 31 can be prevented from being stuck together in a heated state. In this manner, it becomes possible to provide a highly reliable motor free from locking in its rotation.

It is preferred that the lower inner circumferential slanting surface 313 of the sleeve 31 make an acute angle of greater than 0° but smaller than 45° with respect to the center axis J1. Further, it is preferred that the acute angle be set as small as possible as long as the lower inner circumferential slanting surface 313 does not interfere with the sizing bar 71. This helps increase the volume of the sleeve 31 and hence the quantity of oil contained in the sleeve 31. Therefore, it is possible to prolong the lifespan of the sleeve 31 as a bearing.

This also makes it possible to set the contact position between the washer 37 and the lower edge of the lower inner circumferential slanting surface 313 (the inner circumferential edge of the bottom surface of the sleeve 31) to be located more inward in a radial direction. Therefore, it is possible to restrain deformation of the inner circumferential portion of the washer 37 when the shaft 21 is moved in an axially upward direction and brought into contact with the washer 37. This helps establish a structure that keeps the shaft 21 free from removal. Accordingly, it is possible to provide an exceptionally reliable motor.

A second jig 72 is mounted on the upper surface of the sleeve 31. The second jig 72 has a planar surface 721 parallel to the upper surface of the sleeve 31. The upper surface of the sleeve 31 remains in contact with the planar surface 721 of the second jig 72.

When the sleeve 31 is press-fitted to the housing 32, the top surface of the sleeve 31 and the upper surface of the flange portion 323 of the housing 32 are kept in the same axial position by means of the planar surface 721 of the second jig 72. This makes it easier to determine the axial position of the sleeve 31 relative to the housing 32, thereby facilitating the manufacture of the motor and reducing the manufacturing cost thereof.

The planar surface 721 of the second jig 72 is stopped in a position where it makes contact with the upper surface of the flange portion 323. Thus, the press-fitting force of the sleeve 31 is supported by the flange portion 323. Consequently, it is possible to provide a motor of superior quality free from deformation of other regions of the housing 32.

Referring to FIG. 19, the sizing bar 71 includes teeth 711 having a spiral shape and grooves 712 formed between the teeth 711. The teeth 711 serve to cut the inner circumferential surface 311 of the sleeve 31. Therefore, when the sleeve 31 is press-fitted to the inner circumferential surface of the cylindrical holding portion 321, the inner circumferential surface 311 of the sleeve 31 is deformed radially inwardly. Despite such deformation, the inner circumferential surface 311 can be formed to extend along the center axis J1, because the inner circumferential surface 311 of the sleeve 31 is cut by the sizing bar 71. Therefore, it is possible to sharply reduce rotational vibration of the shaft 21.

Referring to FIGS. 20A and 20B, the sizing bar 71 staying in the state shown in FIG. 18B is rotated about the center axis J1 in a specified direction (in the direction indicated by a double-dotted chain line arrow in FIG. 20B) so that it is drawn from the inner circumferential surface 311 of the sleeve 31 (step S4 in FIG. 14). This allows the teeth 711 of the sizing bar 71 to cut the inner circumferential surface 311 of the sleeve 31 along the center axis J1. Since the teeth 711 are of a spiral shape, the powdery cutting chips of the inner circumferential surface 311 of the sleeve 31 are moved via the grooves 712 formed between the neighboring teeth 711 and then discharged from the upper end of the sleeve 31. Therefore, the sizing bar 71 prevents the powdery cutting chips of the inner circumferential surface 311 from staying within the sleeve 31. Use of the sizing bar 71 is particularly desirable when applied to a cup-shaped housing closed at one axial end like the housing 32 of the present invention.

In case the housing has a hollow cylindrical shape as in the prior art example, the sizing bar may penetrate through the inner circumferential surface of the sleeve so that the powdery cutting chips of the inner circumferential surface of the sleeve 31 can be discharged to the outside of the housing. Since the housing 32 has the bottom portion 322 integrally formed therewith, the sizing bar 71 comes into contact with the washer 37 and the thrust plate 38 when allowed to penetrate through the sleeve 31. Further, the powdery cutting chips of the inner circumferential surface of the sleeve 31 are accumulated within the bottom portion 322. This leaves a possibility that the powdery cutting chips may cause the shaft 21 and the sleeve 31 to be stuck together in a heated state. As a result, the motor may possibly be locked during its rotation.

In the present invention, however, the sizing bar 71 is drawn from the inner circumferential surface 311 of the sleeve 31 as shown in FIGS. 20A and 20B. In other words, the teeth 711 of the sizing bar 71 are kept from protruding axially downward beyond the bottom surface of the sleeve 31. This makes sure that the powdery cutting chips of the inner circumferential surface 311 generated by a cutting operation of the sizing bar 71 are discharged from the upper end of the sleeve 31, thereby preventing the shaft 21 and the sleeve 31 from being stuck together in a hearted state. Thus, it becomes possible to provide a highly reliable motor free from locking in its rotation.

The method of press-fitting the sleeve 31 to the housing 32 as illustrated in FIGS. 18A, 18B, 20A and 20B is desirably applied to a structure in which the inner circumferential surface 311 of the sleeve 31 serving as a bearing surface is radially overlapped with a portion of the outer circumferential surface of the sleeve 31 press-fitted to the inner circumferential surface of the cylindrical holding portion 321 of the housing 32.

In case the inner circumferential surface 311 of the sleeve 31 serving as a bearing surface is not radially overlapped with the portion of the outer circumferential surface of the sleeve 31 press-fitted to the inner circumferential surface of the cylindrical holding portion 321 of the housing 32, the inner circumferential surface radially corresponding to that region may preferably be formed radially outward of the inner circumferential surface 311 serving as a bearing surface.

In addition, the outer circumferential surface radially corresponding to the inner circumferential surface 311 serving as a bearing surface may preferably be formed radially inward of that region. In other words, it is preferred that the outer circumferential surface radially corresponding to the inner circumferential surface 311 serving as a bearing surface should not be press-fitted to the inner circumferential surface of the cylindrical holding portion 321.

In the afore-mentioned case, the inner circumferential surface of the sleeve 31 may preferably be cut by the sizing bar 71 in advance and then press-fitted to the cylindrical holding portion 321 of the housing 32. This is desirable in case where the sleeve 31 and the housing 32 can be formed with an increased axial size. If it is not allowed to form the sleeve 31 and the housing 32 with an increased axial size, however, use of such a structure reduces the fixing strength of the sleeve 31 and the housing 32. As a result, the sleeve 31 is moved circumferentially and axially, which may possibly reduce the precision in rotation.

The configuration and manufacturing method of the present invention is desirably applied to a low-profile motor that does not allow the sleeve 31 and the housing 32 to be formed with an increased axial size. In the motor 10 of the present embodiment, the axial length between the lower surface of the attachment plate 34 and the upper surface of the chucking device 40 is equal to 10 mm.

Referring next to FIGS. 21A and 21B, the rotating assembly including the rotating body 20 and the chucking device 40 is attached to the fixed body 30 shown in FIGS. 20A and 20B (step S5 in FIG. 14). This finalizes fabrication of the motor 10.

(Another Embodiment of the Motor)

Next, another embodiment of the motor in accordance with the present invention will be described with reference to FIG. 22, which is an axially-cut schematic section view showing a motor 80 in accordance with another embodiment of the present invention. The motor 80 of the present embodiment is the same as the afore-mentioned motor 10 in terms of the basic configuration. Thus, the same components will be designated by like reference numerals. In the respective components, the portions differing in shape will be designated by like reference numerals with suffix “b”. The portions having a new shape will be will be designated by new reference numerals. No description will be given to the same structures.

Referring to FIG. 22, the attachment plate 34b includes a plate portion 341b; an attachment portion 342b; and an adjustment portion 343 formed between the plate portion 341b and the attachment portion 342b.

The adjustment portion 343 includes a first curved portion 3431 curved downward in an axial direction from a lower surface of the plate portion 341b; a flat portion 3432 formed in parallel with the plate portion 341b; and a second curved portion 3433 that is formed between the flat portion 3432 and the plate portion 341b, and is curved downward in an axial direction from an upper surface of the flat portion 3432. The axial height of the attachment portion 342b and the plate portion 341b can be adjusted by use of the adjustment portion 343.

In general, the distance between an optical pickup device and the lower surface of a disk varies with the kind of a disk drive apparatus. The optical pickup device and the attachment plate are attached to one and the same chassis. Therefore, the distance between the optical pickup device and the lower surface of the disk depends on the distance between the lower surface of the attachment plate 34b and the disk support portion 44 of the rotor holder 22.

If the attachment plate 34b is provided with the adjustment portion 343 as in the motor 80 of the present embodiment, it becomes possible to change the axial length between the plate portion 341b and the disk support portion 44 without having to change the position in which the fitting surface 3422b of the attachment portion 342b is fixed to the attachment plate holding surface section 3212 of the housing 32. This allows the housing 32 to be commonly used even if there exists a difference in the axial length between the plate portion and the disk support portion 44. As a result, it is possible to provide a motor in which the housing 32 is common to varying kinds of disk drive apparatuses.

In particular, since the mold cost of the housing 32 is far greater than that of the attachment plate 34 or 34b, it is possible to reduce the overall mold cost by making the housing 32 usable in common. This makes it possible to provide a low-priced motor.

(Disk Drive Apparatus)

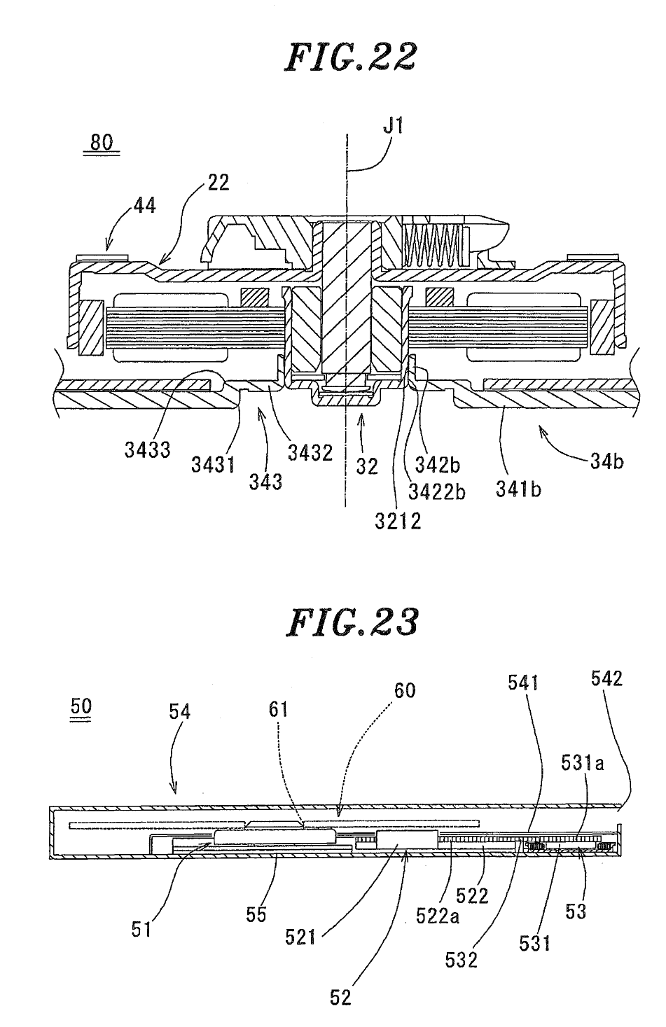

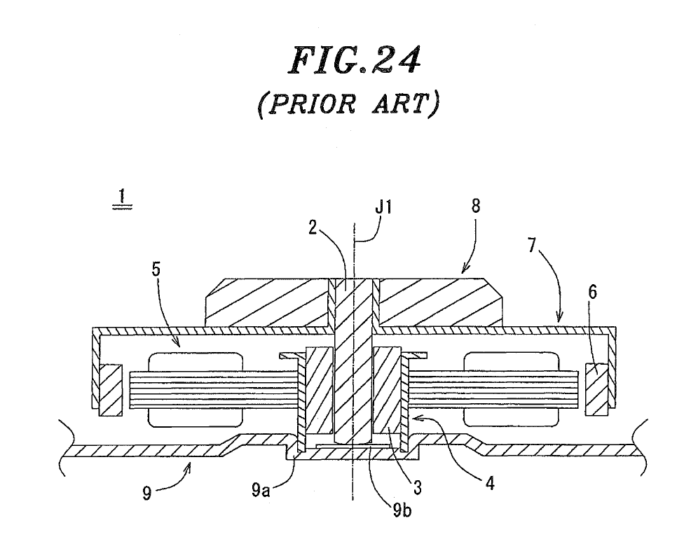

Next, one embodiment of a disk drive apparatus equipped with the present motor will be described with reference to FIG. 23, which is an axially-cut schematic section view of the disk drive apparatus.

Referring to FIG. 23, the disk drive apparatus 50 includes a spindle motor 51 for rotating a disk 60 having a central opening 61, the motor 51 inserted into the central opening 61 of the disk 60 and consequently brought into coaxial alignment with the rotational axis of the disk 60; an optical pickup mechanism 52 for recording and reproducing information on and from the disk 60 by irradiating a laser beam toward the disk 60; a gear mechanism 53 that serves as a moving mechanism for moving the optical pickup mechanism 52 in a radial direction of the disk 60; and a housing 54 for receiving the spindle motor 51, the optical pickup mechanism 52 and the gear mechanism 53.

The spindle motor 51 and the optical pickup mechanism 52 are held in place by means of a chassis 55. As the chassis 55 is caused to move at least in an axial direction, the disk 60 is mounted at the central opening 61 to the chucking device of the spindle motor 51. The chassis 55 is provided with an opening and the optical pickup mechanism 52 is arranged inside the opening.

The gear mechanism 53 includes a motor 531, which has an output shaft and a driving gear attached to the output shaft, and a driven gear 532 for receiving a torque of the motor 531.

A thin partition plate 541 for dividing a moving range of the disk 60 and the gear mechanism 53 is formed within the housing 54. Furthermore, the housing 54 has an access opening 542 through which the disk Go is inserted and taken out.

The optical pickup mechanism 52 includes a recording and reproducing unit 521 for irradiating a laser beam and a moving unit 522 for moving the recording and reproducing unit 521, the moving unit 522 provided at a right angle relative to the moving direction of the recording and reproducing unit 521 that moves along the radial direction of the recording disk 60. The moving unit 522 has a meshing portion 522a that comes into meshing engagement with the driven gear 532. The recording and reproducing unit 521 is meshed with the moving unit 522 and consequently moved in the radial direction.

The driven gear 532 is rotated by coming into meshing engagement with a gear portion 531a attached to the motor 531. The moving unit 522 is moved in the radial direction because the driven gear 532 remains meshed with the meshing portion 522a of the moving unit 522. Upon movement of the moving unit 522, the recording and reproducing unit 521 is moved in the radial direction.

Application of the present motor 10 to the spindle motor 51 of the disk drive apparatus 50 makes it possible to highly accurately arrange the lower surface of the disk 60 in a perpendicular relationship with the light irradiation direction of the optical pickup mechanism 52. Therefore, it is possible to provide a disk drive apparatus that allows the optical pickup mechanism 52 to enjoy increased recording and reproducing precision.

Accordingly, it becomes possible to provide a highly reliable disk drive apparatus capable of preventing generation of recording and reproducing errors which would otherwise be generated when the disk 60 is mounted to the spindle motor 51.

While the invention has been shown and described with respect to the embodiment, it will be understood by those skilled in the art that various changes and modifications may be made without departing from the scope of the invention as defined in the following claims.

What is claimed is:

1. A motor comprising:
a shaft capable of being rotated about a center axis;
a sleeve of a substantially cylindrical shape having an inner circumferential surface that supports the shaft rotatably;
a housing of a substantially cylindrical shape including a cylindrical holding portion having an inner circumferential surface for holding an outer circumferential surface of the sleeve;
a stator, held against an outer circumferential surface of the cylindrical holding portion, for generating a rotating magnetic field; and
an attachment plate, arranged axially below the stator, including an attachment portion held against the outer circumferential surface of the cylindrical holding portion, wherein the housing is made of a press-formed metal plate,
wherein the outer circumferential surface of the cylindrical holding portion has a stator holding surface section facing the stator in a radial direction and an attachment plate holding surface section facing the attachment portion of the attachment plate in a radial direction,
wherein the stator holding surface section has an outer diameter greater than that of the attachment plate holding surface section, and
wherein the inner circumferential surface of the cylindrical holding portion includes a surface region opposite to the stator holding surface section and another surface region opposite to the attachment plate holding surface section, the surface regions being in contact with the outer circumferential surface of the sleeve.

2. The motor of claim 1, wherein the stator is fixed to the stator holding surface section at least by press-fitting.

3. The motor of claim 1, wherein the stator includes:
a stator core having a plurality of stator laminations made of punch-formed thin magnetic plate, the stator laminations being laminated one above another in an axial direction,
wherein the stator laminations are punched in a same punching direction,
wherein the stator core has an inner circumferential surface in contact with the stator holding surface section, and
wherein the attachment plate holding surface section is inserted in the stator core in the punching direction, and the stator core is fitted to and held against the stator holding surface section.

4. The motor of claim 1, wherein a slanting surface whose diameter increases along an axially upward direction is formed between the stator holding surface section and the attachment plate holding surface section.

5. The motor of claim 1, wherein the sleeve is a slide bearing impregnated with oil,
wherein the housing includes a bottom portion that closes off a lower end opening of the cylindrical holding portion,
wherein a thrust plate that rotatably supports a lower end portion of the shaft is disposed on an upper surface of the bottom portion, and
wherein the cylindrical holding portion and the bottom portion are formed as a single body.

6. The motor of claim 1, wherein the inner circumferential surface of the cylindrical holding portion has a curved surface whose diameter increases along an axially upward direction, the curved surface being formed axially above a surface region in the inner circumferential surface of the cylindrical holding portion opposite to the stator holding surface section.

7. The motor of claim 1, wherein the outer circumferential surface of the sleeve is press-fitted to the inner circumferential surface of the cylindrical holding portion,
wherein the outer circumferential surface of the sleeve and the inner circumferential surface of the cylindrical holding portion make contact with each other over an axial length of about 4 mm or less, and
wherein the axial length is substantially the same as an axial length over which the outer circumferential surface of the shaft makes contact with the inner circumferential surface of the sleeve.

8. The motor of claim 1, wherein the attachment portion of the attachment plate is formed by burring,
wherein the attachment portion of the attachment plate includes an increased diameter portion in which an inner diameter of the attachment portion is larger than in the other part of the attachment portion,
wherein the inner diameter of the increased diameter portion is greater than an outer diameter of the attachment plate holding surface section, and
wherein a portion of the inner circumferential surface of the attachment portion lying axially below the increased diameter portion is fitted to and held against the attachment plate holding surface section.

9. The motor of claim 8, wherein the attachment portion has a radial thickness of about 0.6 mm or less.

10. The motor of claim 8, wherein an adhesive agent is filled between an inner circumferential surface of the increased diameter portion of the attachment portion and the attachment plate holding surface section.

11. The motor of claim 8, wherein a slanting surface whose diameter increases along an axially upward direction is formed at an upper edge of the inner circumferential surface of the increased diameter portion.

12. The motor of claim 8, wherein a slanting surface whose diameter increases along an axially upward direction is formed between the inner circumferential surface of the increased diameter portion and a part of the inner circumferential surface of the attachment portion that is in contact with the attachment plate holding surface section.

13. The motor of claim 8, wherein a radially inwardly curved portion is extended from a lower end of the attachment plate holding surface section.

14. The motor of claim 1, wherein a step portion, at which the outer diameter and the inner diameter of the housing are reduced, is formed at an axial lower end of the cylindrical holding portion,
wherein a bottom portion for closing off a lower opening of the housing is extended from the step portion,
wherein a washer whose inner diameter is smaller than that of the sleeve is arranged between a bottom surface of the sleeve and an upper surface of the step portion,
wherein a reduced diameter portion is formed at a part of the outer circumferential surface of the shaft that faces the washer in a radial direction, and
wherein the reduced diameter portion has an axial length greater than that of an inner circumferential surface of the washer.

15. The motor of claim 14, wherein the step portion is connected to the cylindrical holding portion via a curved portion,
wherein a downwardly recessed annular groove portion is formed at an outer circumferential edge of the upper surface of the step portion, and
wherein an outer circumferential edge of the washer is located radially outwardly of an inner circumferential edge of the annular groove portion.

16. The motor of claim 1, further comprising:
a rotor holder attached to an upper portion of the shaft, the rotor holder including a cylinder portion for holding a rotor magnet radially facing the stator and a cover portion for covering the stator and the sleeve; and
a chucking device arranged on an upper surface of the cover portion of the rotor holder for holding an optical disk having a central opening portion in a removable manner,
wherein a disk support portion for making contact with a lower surface of the optical disk is provided on an upper surface of the cover portion of the rotor holder radially outwardly of the chucking device.

17. The motor of claim 16, wherein a printed circuit board having an aperture that is substantially coaxial with the center axis is arranged on the upper surface of the attachment plate, an inner diameter of the aperture being greater than an outer diameter of the attachment portion, and
wherein an adjustment portion having an axially stepped shape for adjusting an axial distance between a lower surface of the attachment plate and an upper surface of the disk support portion is formed radially between the attachment portion and the aperture.

18. A disk drive apparatus for recording and reproducing data in a disk, comprising:
the motor of claim 16;
an optical pickup mechanism for optically recording and reproducing data in the disk;
a moving mechanism for moving the optical pickup mechanism in a radial direction of the disk; and
a chassis to which the motor is attached,
wherein the chassis has an opening, and the optical pickup mechanism is arranged inside the opening.

19. A method for manufacturing a motor, comprising:
providing a shaft capable of being rotated about a center axis;
providing a sleeve of a substantially cylindrical shape having an inner circumferential surface that supports the shaft rotatably;
press-forming a metal plate into a housing of a substantially cylindrical shape including a cylindrical holding portion having an inner circumferential surface for holding an outer circumferential surface of the sleeve;
providing a stator, held against an outer circumferential surface of the cylindrical holding portion, for generating a rotating magnetic field; and
providing an attachment plate, arranged axially below the stator, including an attachment portion held against the outer circumferential surface of the cylindrical holding portion;
wherein the outer circumferential surface of the cylindrical holding portion has a stator holding surface section facing the stator in a radial direction and an attachment plate holding surface section facing the attachment portion of the attachment plate in a radial direction,
wherein the stator holding surface section has an outer diameter greater than that of the attachment plate holding surface section,
wherein the inner circumferential surface of the cylindrical holding portion includes a surface region opposite to the stator holding surface section and another surface region opposite to the attachment plate holding surface section, the surface regions being in contact with the outer circumferential surface of the sleeve,
wherein the stator is attached to the stator holding surface section by fitting the stator therethroug, and
wherein the attachment portion of the attachment plate is attached to the attachment plate holding surface section after the stator has been attached to the stator holding surface section.

20. The method of claim 19, wherein the stator and the attachment plate are respectively press-fitted to the stator holding surface section and the attachment plate holding surface section.

21. The method of claim 19, wherein the sleeve is press-fitted to the inner circumferential surface of the cylindrical holding portion of the housing, and
wherein a sizing bar for cutting the inner circumferential surface of the sleeve is inserted through the inner circumferential surface of the sleeve when the sleeve is press-fitted to the inner circumferential surface of the cylindrical holding portion.

22. The method of claim 21, wherein an annular flange portion that widens in an outwardly radial direction is formed at an upper end portion of the cylindrical holding portion, and
wherein the sleeve is press-fitted to a position where a top surface of the sleeve is flush with an upper surface of the flange portion.

23. The method of claim 19, wherein a step portion having a reduced outer diameter and a reduced inner diameter is formed at an axial lower end of the cylindrical holding portion,
wherein a bottom portion that closes off a lower opening of the cylindrical holding portion is formed in the step portion,
wherein a washer having an inner diameter smaller than that of the sleeve is arranged axially between a bottom surface of the sleeve and an upper surface of the step portion,
wherein a reduced diameter portion is formed on the outer circumferential surface of the shaft to face the washer in a radial direction, and
wherein a tip end portion of the sizing bar lies substantially in the same axial position as the bottom surface of the sleeve that faces the washer or lies axially above the bottom surface of the sleeve.

24. The method of claim 23, wherein an annular upper slanting surface and an annular lower slanting surface are respectively formed at an upper and a lower edge of the inner circumferential surface of the sleeve, and
wherein the lower slanting surface is greater in size than the upper slanting surface.

25. The method of claim 24, wherein the lower slanting surface and the center axis make an acute angle greater than 0° but smaller than 45°.

26. The method of claim 21, wherein the sizing bar has a spiral groove formed on an outer circumferential surface of the sizing bar.

27. The method of claim 19, wherein an annular flange portion that widens in an outwardly radial direction is formed at an upper end portion of the cylindrical holding portion of the housing, the flange portion having an inner circumferential surface partially overlapped with the cylindrical holding portion in an axial direction,
wherein the housing is arranged on a jig in a state that the flange portion makes contact with the jig, and
wherein the stator and the attachment plate are respectively press-fitted to the stator holding surface section and the attachment plate holding surface section.
